(19) United States
(12) Patent Application Publication
(10) Pub. No.: US 2011/0238217 A1
(43) Pub. Date: Sep. 29, 2011

(54) TRANSFER SUPPORTING APPARATUS

(76) Inventors: Yohei Kume, Osaka (JP); Hideo Kawakami, Osaka (JP); Soichiro Fujioka, Osaka (JP); Tohru Nakamura, Osaka (JP)

(21) Appl. No.: 12/527,966

(22) PCT Filed: Mar. 28, 2008
(86) PCT No.: PCT/JP2008/000796

§ 371 Date: Aug. 20, 2009

(30) Foreign Application Priority Data
Apr. 12, 2007 (JP) 2007-104757
Sep. 11, 2007 (JP) 2007-234929

(51) Int. Cl. G05B 15/02

(52) U.S. Cl. 700/275

(57) ABSTRACT

A transfer supporting apparatus is provided with actuators for actuating supporting members and a controller for controlling the actuators based on the operation of operating units. The controller includes a movement path setting unit for setting movement paths of the supporting members and an operation correcting unit for correcting movements of the supporting members based on the operation of the operating units by driving the actuators so that the supporting members move along the movement paths set by the movement path setting unit.

### FIELD OF THE INVENTION

The present invention relates to a transfer supporting device for supporting a transfer operation performed by a person in hospitals, at home and the like.

### DESCRIPTION OF THE RELATED ART

There have been proposed transfer supporting apparatuses for caring for the transport of patients lying on beds and nursing aid robots for bathing in hospitals and at home (see, for example, patent literatures 1 and 2). These have been proposed for the purpose of supporting heavy lifting and reducing physical burdens of caregivers.
Patent Literature 1: Japanese Unexamined Utility Model Publication No. S62-64525
Patent Literature 2: Japanese Examined Patent Publication No. H06-9587

A transfer supporting apparatus is a apparatus for supporting an operation of a caregiver to transfer a care recipient to a bed, for example, in a hospital or at home. In the case of operating the transfer supporting apparatus by a caregiver with a low skill, a possibility of such an operation as to impose a burden on a care recipient such as causing the care recipient to take an improper physical posture cannot be denied.

### SUMMARY OF THE INVENTION

An object of the present invention is to provide a more easily operable transfer supporting apparatus.

A transfer supporting apparatus according to the present invention comprises a supporting member for supporting a person and an operating unit for operating the supporting member. The supporting member is moved based on the operation of the operating unit to lift up the person. This transfer supporting apparatus comprises an actuator for actuating the supporting member and a controller for controlling the actuator based on the operation of the operating unit. The controller includes a movement path setting unit for setting a movement path along which the supporting member is moved. The controller also includes an operation correcting unit for correcting the movement of the supporting member based on the operation of the operating unit by driving the actuator so that the supporting member moves along the movement path set by the movement path setting unit.

### BRIEF DESCRIPTION OF THE DRAWINGS

FIG. 1 is a perspective view showing a used state of a transfer supporting apparatus according to one embodiment of the invention,

FIG. 2 is a perspective view showing the structure of an essential part of the transfer supporting apparatus,

FIG. 3 is a block diagram showing an electrical construction of the transfer supporting apparatus,

FIG. 4 is a block diagram showing a construction relating to a movement control of the transfer supporting apparatus,

FIG. 5 is a perspective view showing the definition of movement posture/path of the transfer supporting apparatus,

FIG. 6 is a block diagram of a movement control information generating unit of the transfer supporting apparatus,

FIG. 7 is a diagram showing a relative positional relationship of a care recipient and supporting members in the transfer supporting apparatus,

FIGS. 8A and 8B are graphs showing virtual potential energies at points on a first movement posture/path of the transfer supporting apparatus,

FIGS. 9A to 9D are diagrams and graphs showing a relationship between the posture of a care recipient and the virtual potential energy in the transfer supporting apparatus,

FIGS. 10A to 10C are graphs showing virtual potential energies at points on a second movement posture/path of the transfer supporting apparatus,

FIG. 11 is a flow chart showing the operation of the transfer supporting apparatus,

FIG. 12 is a perspective view showing a transfer supporting apparatus according to another embodiment of the invention,

FIG. 13 is a perspective view showing a used state of the transfer supporting apparatus,

FIG. 14 is a block diagram showing the construction of a controller of the transfer supporting apparatus,

FIG. 15 is a side view showing the construction of the transfer supporting apparatus,

FIG. 16 is a plan view showing a used state of the transfer supporting apparatus,

FIG. 17 is a plan view showing a movement path set in the transfer supporting apparatus,

FIG. 18 is a side view showing the movement path set in the transfer supporting apparatus,

FIG. 19 is a plan view showing virtual potential energies set in the transfer supporting apparatus,

FIG. 20 is a side view showing the virtual potential energies set in the transfer supporting apparatus,

FIG. 21 is a side view showing a bending angle of a care recipient in the transfer supporting apparatus of this embodiment,

FIG. 22 is a side view showing a bending angle of the care recipient in the transfer supporting apparatus of this embodiment,

FIG. 23 is a side view showing a movement path set in a lift-up operation in the transfer supporting apparatus of this embodiment,

FIG. 24 is a side view showing a movement path set in a lift-up operation in the transfer supporting apparatus of this embodiment,

FIG. 25A is a graph showing the concept of virtual potential energy in the transfer supporting apparatus of this embodiment and FIG. 25B is a graph showing an exemplary model upon calculating a force F(x1) according to the virtual potential energy,

FIG. 26 is a diagram showing a relationship between physique information and the set virtual potential energy in the transfer supporting apparatus of this embodiment,

FIG. 27 is a graph showing an example of virtual potential energy set in the transfer supporting apparatus of this embodiment,

FIG. 28 is a graph showing another example of virtual potential energy set in the transfer supporting apparatus of this embodiment, and

FIG. 29 is a diagram showing a mode transfer set in a controller of the transfer supporting apparatus of this embodiment.

### DETAILED DESCRIPTION OF THE PREFERRED EMBODIMENTS THE INVENTION

Hereinafter, a transfer supporting apparatus according to one embodiment of the present invention is described with reference to the drawings. The following embodiment is to illustratively describe the present invention and the present invention is not limited to the embodiment described below. In this specification, “front”, “rear”, “left”, “right”, “upper” and “lower” comply with forward, rearward, leftward, rightward, upward and downward directions in a normal operational posture of an operator operating the transfer supporting apparatus. In the drawings, front, rear, left and right are appropriately indicated by “Fr”, “Rr”, “L” and “R” according to needs. The respective drawings are shown on the premise of being seen in directions of arrows.

In this embodiment, a transfer supporting apparatus 200 is provided with a supporting member 201, operating units 202, actuators (301a, 301b to 305a, 305b) and a controller 310.

The supporting member 201 is a member for supporting a person. In this embodiment, the supporting member 201 is supported on a movable body 205 assisting the movement of the transfer supporting apparatus 200.

The movable body 205 includes a pair of left and right bases 211, 212 and coupling portions 213, 214. The left and right bases 211, 212 include wheels 215 and first drivers 301a, 301b for driving the wheels 215. In this embodiment, wheels movable in every direction are mounted as the wheels 215. Specifically, omni wheels or mecanum wheels can be used as the wheels 215 movable in every direction. The coupling portions 213, 214 are members for coupling the left and right bases 211, 212, and bridge the left and right bases 211, 212 at two front and rear positions. The coupling portions 213, 214 have telescopic mechanisms and extend and contact according to a distance between the left and right bases 211, 212. Although the coupling portions for coupling the left and right bases 211, 212 are provided at two front and rear positions of the left and right bases 211, 212 in this embodiment, the number of the coupling portions is not limited to two and may be, for example, one. The coupling portions may be arranged at such positions as not to hinder the operation of an operator operating the transfer supporting apparatus. In this embodiment, the coupling portions 213, 214 are arranged at such a height in a lower part of the transfer supporting apparatus 200 that the operator can step over them. In this way, accessibility of the operator to an operational position is improved.

This transfer supporting apparatus 200 is provided with the supporting member 201 including a first supporting member 201a and a second supporting member 201b. In this embodiment, the first supporting member 201a is mounted on the left base 211 and the second supporting member 201b is mounted on the right base 212. In this embodiment, the first and second supporting members 201a, 201b respectively include arm units 221a, 221b and hand units 222a, 222b. Base ends of the arm units 221a, 221b are respectively mounted on the left and right bases 211, 212. The arm units 221a, 221b include first arms 231a, 231b, first joints 232a, 232b, second arms 233a, 233b and second joints 234a, 234b in this order from the base ends.

The first arms 231a, 231b include telescopic sliding mechanisms 235a, 235b and second drivers 302a, 302b for driving the sliding mechanisms 235a, 235b. In this embodiment, the first arms 231a, 231b become longer by extending the sliding mechanisms 235a, 235b. Further, the first arms 231a, 231b become shorter by contracting the sliding mechanisms 235a, 235b. In this embodiment, the transfer supporting apparatus 200 can adjust the heights of the first and second supporting members 201a, 201b by adjusting the lengths of the first arms 231a, 231b.

The first joints 232a, 232b are members for coupling the first arms 231a, 231b and the second arms 233a, 233b in a bendable manner. Third drivers 303a, 303b are mounted in the first joints 232a, 232b. The third drivers 303a, 303b drive the first joints 232a, 232b to change bending angles of the first arms 231a, 231b and the second arms 233a, 233b.

The hand units 222a, 222b are mounted at the leading ends of the second arms 233a, 233b via the second joints 234a, 234b. The second joints 234a, 234b couple the hand units 222a, 222b rotatably about lengthwise axes of the second arms 233a, 233b. Fourth drivers 304a, 304b are mounted in the second joints 234a, 234b. The fourth drivers 304a, 304b drive the second joints 234a, 234b to change angles of rotation of the hand units 222a, 222b about the lengthwise axes of the second arms 233a, 233b with respect to the second arms 233a, 233b.

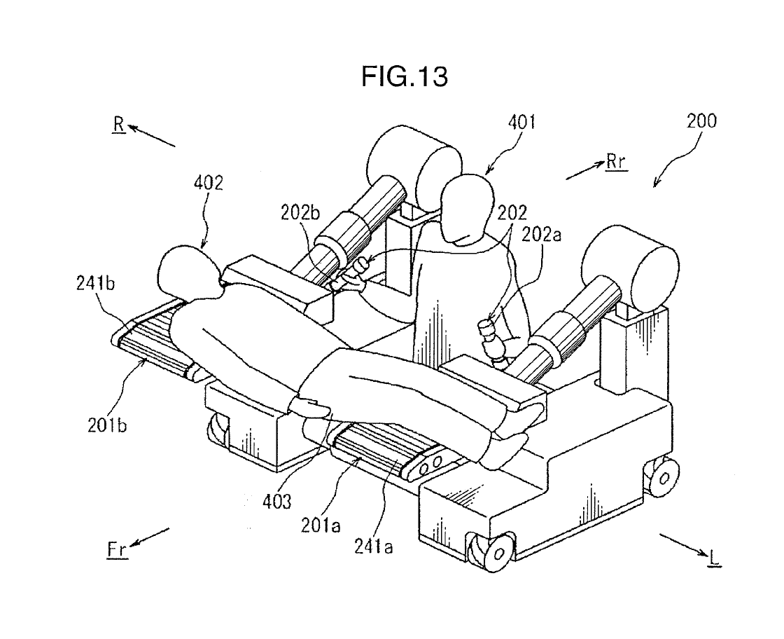

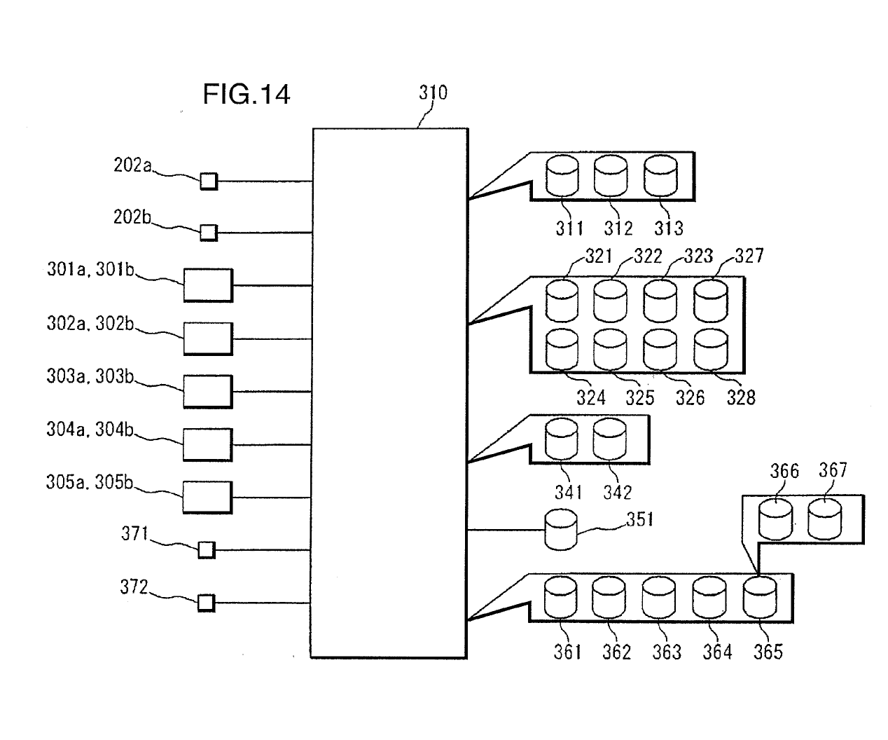

As shown in FIG. 13, the hand units 222a, 222b are parts for supporting a person (care recipient 402). In this embodiment, the transfer supporting apparatus 200 includes the operating units 202 used by a caregiver 401 (operator) to operate the supporting member 201 and provided at the hand units 222a, 222b. In this embodiment, the transfer supporting apparatus 200 includes operation levers 202a, 202b as the operating units 202 respectively at the left and right hand units 222a, 222b. In this embodiment, six-axis force sensors are mounted in the operation levers 202a, 202b and can detect operation forces input to the operation levers 202a, 202b in six axial directions of translation and rotation. Information on operational inputs to the operation levers 202a, 202b is sent to the controller 310 as shown in FIG. 14.

As shown in FIG. 13, the caregiver 401 (operator) enters between the first and second supporting members 201a, 201b at the left and right sides to operate the left and right operation levers 202a, 202b in this transfer supporting apparatus 200. The caregiver 401 can operate the operation levers 202a, 202b to move the transfer supporting apparatus 200 and operate the first and second supporting members 201a, 201b.

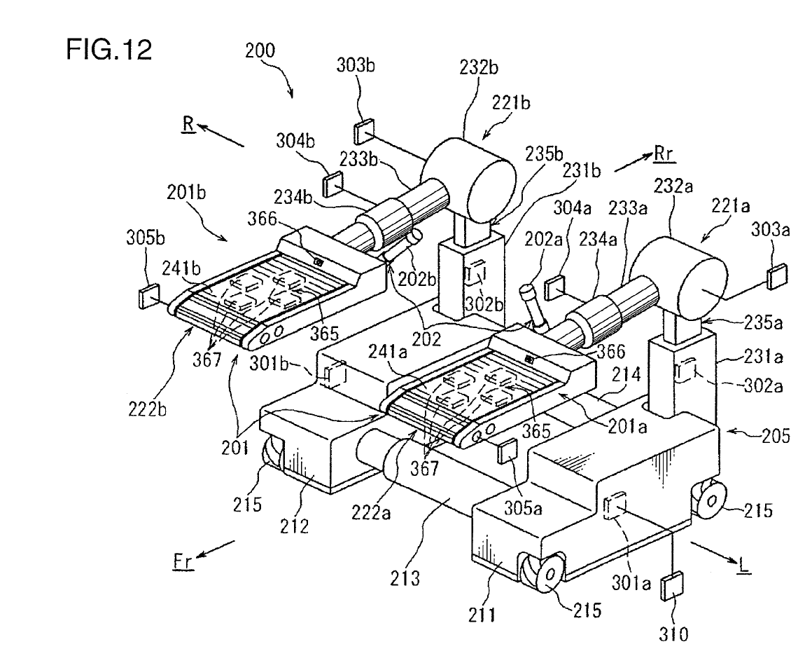

In this embodiment, the hand units 222a, 222b have a flat shape and conveyor belts 241a, 241b are exposed from the leading ends to the upper surfaces of the hand units 222a, 222b. The hand units 222a, 222b include fifth drivers 305a, 305b for moving the conveyor belts 241a, 241b. Further in this embodiment, the hand units 222a, 222b include detection sensors 365 for detecting whether or not the hand units 222a, 222b are supporting a person. In this embodiment, proximity sensors 366 and pressure sensors 367 are provided as the detection sensors 365 as shown in FIG. 12. The proximity sensors 366 are arranged at the base ends of the hand units 222a, 222b so that sensing units thereof are faced toward the leading ends. Further, a plurality of pressure sensors 367 are distributed on the upper surface of each of the hand units 222a, 222b.

In this way, the hand units 222a, 222b can detect a state supporting a person by the proximity sensors 366 or the pressure sensors 367 upon supporting the person (care recipient 402). The proximity sensors 366 mainly detect whether or not the care recipient 402 is placed up to the base ends of the hand units 222a, 222b. The plurality of pressure sensors 367 distributed on the upper surfaces of the hand units 222a, 222b detect whether or not the upper surfaces of the hand units 222a, 222b are supporting the care recipient 402 by equal forces. In this embodiment, whether or not the upper surfaces of the hand units 222a, 222b are properly supporting the care recipient 402 can be detected by the proximity sensors 366 or the pressure sensors 367. Detection information of the proximity sensors 366 and the pressure sensors 367 as the detection sensors 365 is sent to the controller 310 as shown in FIG. 14.

This transfer supporting apparatus 200 is a apparatus for lifting up the care recipient 402 by the supporting member 201 by operating the supporting member 201 based on the operation of the caregiver 401. Specifically, in this embodiment, the transfer supporting apparatus 200 supports the upper body of the care recipient 402 by one 201b of the first and second supporting members 201a, 201b while supporting the lower body of the care recipient 402 by the other supporting member 201a as shown in FIG. 13 with an example.

As shown in FIG. 12, this transfer supporting apparatus 200 includes the actuators (301a, 301b to 305a, 305b) and the controller 310 as shown in FIG. 12. The actuators (301a, 301b to 305a, 305b) actuate the transfer supporting apparatus 200 and the supporting member 201. In this embodiment, the transfer supporting apparatus 200 includes the first to fifth drivers 301a, 301b to 305a, 305b as the actuators. The first to fifth drivers 301a, 301b to 305a, 305b are respectively motors controllable by the controller 310.

As shown in FIG. 13, the respective drivers (actuators 301a, 301b to 305a, 305b) assist forces for the operation of the caregiver 401 in this transfer supporting apparatus 200. Thus, the caregiver 401 can easily move the transfer supporting apparatus 200 and operate the first and second supporting members 201a, 201b. Since forces are assisted by the respective drivers also upon lifting up the care recipient 402, the care recipient 402 can be easily lifted up. In this embodiment, the operation of the caregiver 401 is corrected by the controller 310.

Next, the controller 310 is described.

As shown in FIG. 14, the controller 310 controls the actuators (301a, 301b to 305a, 305b) based on the operation of the operating units 202. In this embodiment, the controller 310 includes a movement path setting unit 311, an operation correcting unit 312 and a virtual potential energy setting unit 313. In this embodiment, the controller 310 further includes storages and computing sections such as a physique information storage 321, a body information storage 322, a permissible bending angle setting unit 323, a bending angle calculating unit 324, a correction canceling unit 325, a movement path correcting unit 326, a hip joint specifying unit 327 and a posture information storage 328. In order to obtain various pieces of information, the controller 310 includes first detectors 361, second detectors 362, pressure sensors 363, a hip detector 364 and the detection sensors 365.

The movement path setting unit 311 sets a movement path along which the supporting member 201 is operated. Such a movement path is set in accordance with a program stored in the controller 310 beforehand. The operation correcting unit 312 drives the actuators (301a, 301b to 305a, 305b) so that the supporting member 201 operates along the movement path set by the movement path setting unit 311, thereby correcting the movement of the supporting member 201 based on the operation of the operating units 202. These storages and computing units and various sensors of the controller are described in detail later.

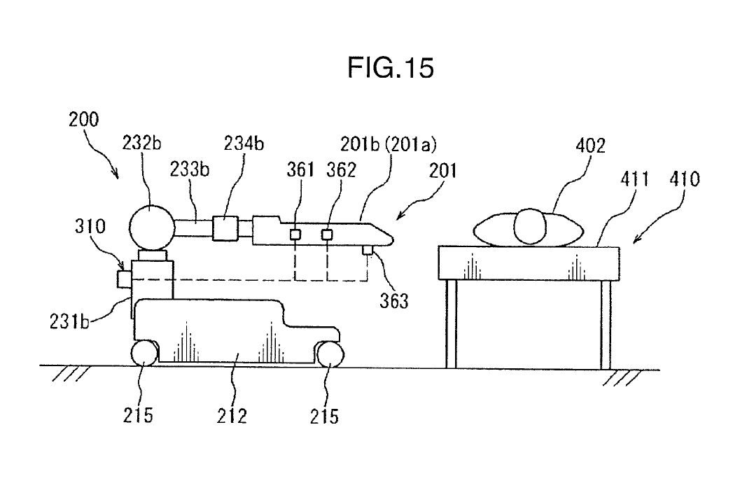

As shown in FIG. 15, the transfer supporting apparatus 200 of this embodiment can be used as an apparatus for supporting a transfer operation of the care recipient 402 lying on a bed 410 (placing tool). Here, any thing on which a person can lie is broadly called a “placing tool”. Here, “placing tools” include the bed illustrated in this embodiment, beds fitted with casters, nursing wheelchairs transformable into forms on which a person can lie.

In this embodiment, the transfer supporting apparatus 200 includes the first detectors 361 for detecting a distance between the bed 410 and the supporting member 201 as shown in FIG. 15. The first detectors 361 may detect the distance between the bed 410 and the supporting member 201, for example, using known distance sensors. Information detected by the first detectors 361 is sent to the controller 310 as shown in FIG. 14.

As shown in FIG. 15, the transfer supporting apparatus 200 includes the second detectors 362 for detecting a placing surface 411 (bed surface) of the bed 410. Here, the “placing surface” means a surface of the bed 410 on which a person is laid. Various detectors for detecting the placing surface 411 of the bed 410 can be used as the second detectors 362.

In this embodiment, pressure sensors, proximity switches, and the like are mounted on the lower surfaces of the hand units 222a, 222b of the supporting member 201 as the second detectors 362. When the second detectors 362 detect the placement of the lower surfaces of the hand units 222a, 222b on the placing surface 411, the controller 310 saves the height at the time of this detection as the height of the placing surface 411. In this case, the hand units 222a, 222b of the above supporting member 201 may be manually brought into contact with the placing surface 411 beforehand to save the height of the placing surface 411 in the controller 310. The construction of the second detectors 362 is not limited to the above construction. The second detectors 362 may be, for example, so constructed as to detect the height of the placing surface 411 (bed surface) of the bed 410 by distance sensors. Alternatively, the height of the placing surface 411 (bed surface) of the bed 410 may be detected by processing an image obtained by a camera installed in the transfer supporting apparatus 200.

In this embodiment, the pressure sensors 363 are mounted on the undersides of the hand units 222a, 222b of the first and second supporting members 201a, 201b as shown in FIG. 15. These pressure sensors 363 can detect a contact pressure between the supporting member 201 (undersides of the hand units 222a, 222b) and the bed 410 (placing tool). Information detected by the pressure sensors 363 is sent to the controller 310.

This transfer supporting apparatus 200 successively performs a first step of placing the care recipient 402 lying on the bed 410 onto the supporting member 201 (hand units 222a, 222b), a second step of lifting up the care recipient lying on the bed 410, a third step of moving the care recipient 402 while lifting him up, a fourth step of lowering the care recipient 402 and a fifth step of pulling the supporting member 201 (hand units 222a, 222b) out.

First of all, the first step of placing the care recipient 402 lying on the bed 410 onto the supporting member 201 (hand units 222a, 222b) is described.

The controller 310 sets a movement path of the supporting member 201 in the first step of placing the care recipient 402 lying on the bed 410 onto the supporting member 201 (hand units 222a, 222b).

In this embodiment, the controller 310 includes the physique information storage 321 as shown in FIG. 14. The physique information storage 321 stores physique information on the physique of the care recipient 402. The physique information stored in the physique information storage 321 includes height information and weight information. In this embodiment, the movement path setting unit 311 sets a movement path of the supporting member 201 according to the physique of the care recipient 402 based on the physique information stored in the physique information storage 321.

In this embodiment, the controller 310 also includes the body information storage 322. Body information stored in this body information storage 322 includes information on abnormal parts of the body. Such abnormal parts of the body are, for example, bedsore parts or wounded body parts due to injuries, specifically body parts which cannot be supported by the supporting member 201. In this embodiment, the abnormal parts are stored in the body information storage 322 beforehand for each care recipient.

In this embodiment, the transfer supporting apparatus 200 also includes the hip detector 364 for detecting the position of a hip 403 of a person. This “hip” includes a hip joint. The hip detector 364 may detect the hip 403 of the person by a specified program, for example, based on an image photographed by a camera installed in the transfer supporting apparatus 200. Alternatively, the hip 403 of the person may be detected (in this case, the position of the hip of the person is estimated) from the height information stored in the physique information storage 321 and data on standard physiques of people obtained beforehand.

In the first step, the supporting member 201 (hand units 222a, 222b) is inserted below the care recipient lying on the bed 410. In this embodiment, the transfer supporting apparatus 200 first specifies an insertion position of the supporting member 201 (hand units 222a, 222b) with respect to the care recipient lying on the bed 410. Subsequently, the transfer supporting apparatus 200 sets an optimal movement path along which the supporting member 201 should be moved with respect to the care recipient from the present position. Further, in response to the operation of the operator (caregiver), the operation correcting unit 312 drives the actuators (301a, 301b to 305a, 305b) so that the supporting member 201 moves along the movement path set by the movement path setting unit 311, thereby correcting the movement of the supporting member 201 based on the operation of the operating units 202.

Specifically, the movement path setting unit 311 first specifies the insertion position of the supporting member 201 (hand units 222a, 222b) with respect to the care recipient lying on the bed 410. In this embodiment, body parts which cannot be supported by the supporting member 201 are stored as the body information in the body information storage 322. For example, bedsore parts or wounded body parts by injuries are stored. Accordingly, the insertion position of the supporting member 201 (hand units 222a, 222b) may be specified so that the body parts stored in the body information storage 322 deviate from the insertion position of the supporting member 201 (hand units 222a, 222b).

This transfer supporting apparatus 200 operates, for example, so that the upper body above the hip 403 is supported by the one 201b of the first and second supporting members 201a, 201b and the lower body below the hip 403 is supported by the other supporting member 201a. In this embodiment, the care recipient 402 is supported around the shoulder blades of the back by the one supporting member 201b and around the backs of the knees by the other supporting member 201a.

In this embodiment, the physique information stored in the physique information storage 321 includes information on height (height information). Based on the height information stored in the physique information storage 321, the movement path setting unit 311 sets a distance between the both supporting members 201a and 201b when the first and second supporting members 201a, 201b are inserted below the care recipient 402.

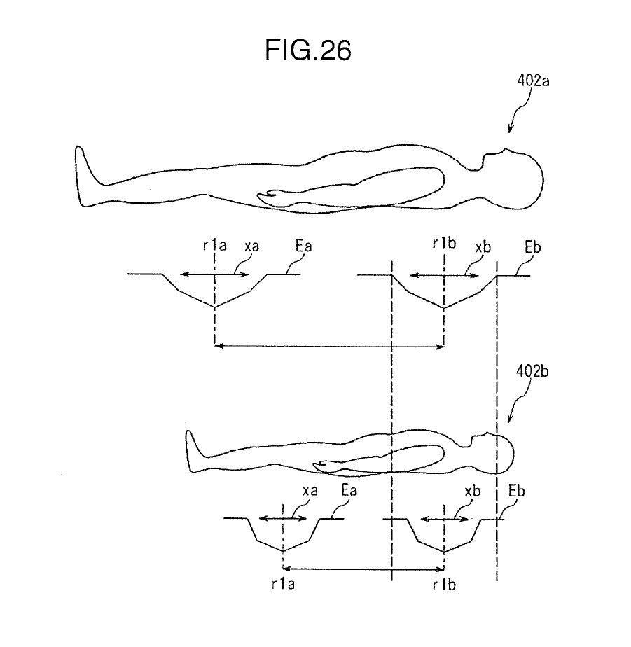

Specifically, in this embodiment, the controller 310 includes a first database 351 for specifying an optimal distance between the first and second supporting members 201a, 201b based on the height. The controller 310 sets the distance between the first and second supporting members 201a, 201b based on the height information stored in this first database 351 and the physique information storage 321. For example, as shown in FIG. 26, a distance between movement paths r1a, r1b set for the both supporting members 201a, 201b upon inserting the supporting members 201a, 201b below the care recipient 402 is narrower for a short care recipient 402b than for a tall care recipient 402a.

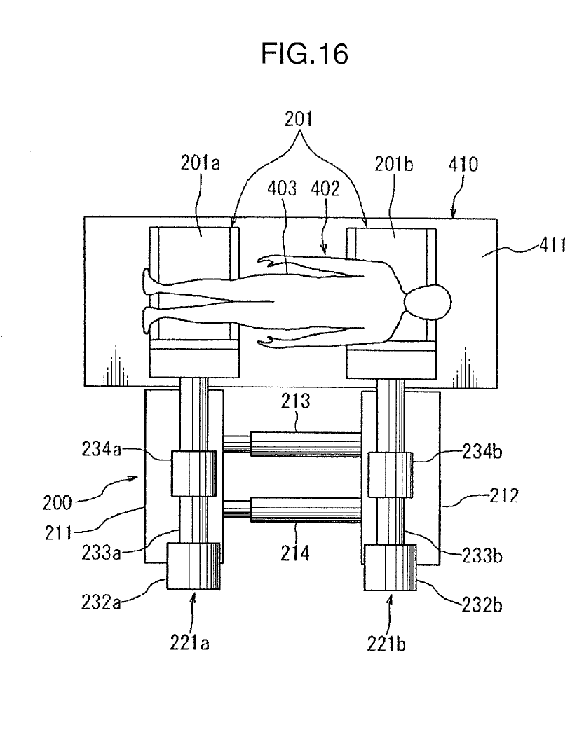

In this embodiment, as shown in FIG. 16, the distance between the first and second supporting members 201a, 201b is set so that the one of the first and second supporting members 201a, 201b is inserted below the vicinity of the shoulder blades of the back of the care recipient 402 and the other supporting member is inserted below the vicinity of the back of the knees of the care recipient 402.

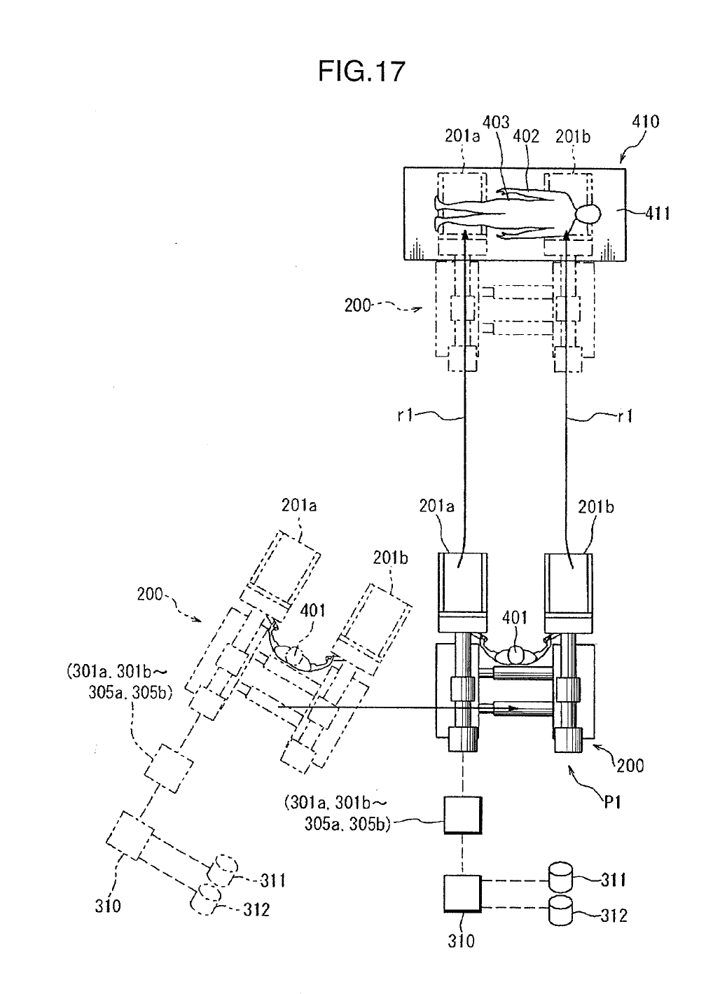

In this embodiment, the transfer supporting apparatus 200 detects the position of the hip 403 of the care recipient 402 by the hip detector 364. The movement path setting unit 311 sets the movement paths of the first and second supporting members 201a, 201b based on the position of the hip 403 detected by the hip detector 364 as shown in FIG. 17. In this embodiment, the movement path setting unit 311 specifies the positions of the shoulder blades of the back and the positions of the backs of the knees of the care recipient 402 based on the position of the hip 403 detected by the hip detector 364. The movement path setting unit 311 respectively sets the movement paths r1 of the first and second supporting members 201a, 201b based on the specified positions. In this way, the movement paths r1 of the first and second supporting members 201a, 201b are respectively set so that the one of the first and second supporting members 201a, 201b is inserted below the vicinity of the shoulder blades of the back of the care recipient 402 and the other supporting member is inserted below the vicinity of the backs of the knees of the care recipient 402.

In this embodiment, the information on the abnormal body parts is stored in the body information storage 322. For example, if the vicinity of the shoulder blades of the back of the care recipient 402 or the vicinity of the backs of the knees is stored as the body part, which cannot be supported by the supporting member 201, in the body information storage 322, the insertion positions of the first and second supporting members 201a, 201b below the care recipient 402 are set while being deviated from the stored body part. In this embodiment, the controller 310 also includes a first setting unit 341 for setting the insertion positions as shown in FIG. 14. The first setting unit 341 may set the positions of the care recipient 402 supported by the first and second supporting members 201a, 201b, for example, considering this situation of the care recipient 402. Thus, the positions of the care recipient 402 to be supported by the first and second supporting members 201a, 201b can be flexibly changed according to individual situations of the care recipient 402.

In this embodiment, as shown in FIG. 14, the controller 310 includes a checking unit 342 for checking whether or not the care recipient 402 can be safely supported by the first and second supporting members 201a, 201b. In this embodiment, this checking unit 342 models the care recipient 402 supported by the first and second supporting members 201a, 201b as a physical model based on the information stored in the physique information storage 321. Based on this physical model, whether or not the care recipient 402 can be stably supported by the first and second supporting members 201a, 201b is confirmed in accordance with a specified program. Thus, even if the positions of the care recipient 402 the caregiver 401 supports using the first and second supporting members 201a, 201b are changed, for example, by the first setting unit 341, safety can be ensured.

As described above, in this embodiment, the insertion positions of the first and second supporting members 201a, 201b below the care recipient 402 can be set by the first setting unit 341. If the insertion positions of the first and second supporting members 201a, 201b below the care recipient 402 are set by the first setting unit 341, the controller 310 sets the movement paths of the first and second supporting members 201a, 201b so as to guide the first and second supporting members 201a, 201b to these positions.

The movement paths are those from the present positions of the first and second supporting members 201a, 201b to the respective insertion positions. The controller 301 sets the movement paths of the respective supporting members 201a, 201b so that the supporting members 201a, 201b are respectively smoothly inserted below the vicinity of the shoulder blades of the back of the care recipient 402 and the vicinity of the backs of the knees of the care recipient 402. Further, in this embodiment, the movement paths r1 are set so that the first and second supporting members 201a, 201b substantially simultaneously reach the vicinity of the care recipient 402 as shown in FIG. 17. Thus, in this embodiment, the transfer supporting apparatus 200 first moves to a position suitable to insert the supporting member 201. The movement paths r1 are set so that the first and second supporting members 201a, 201b face toward the care recipient 402 from that position and approach the care recipient 402.

In this embodiment, the transfer supporting apparatus 200 is moved to a first position P1 where the first and second supporting members 201a, 201b face straight toward a lateral side of the bed 410 on which the care recipient 402 is lying as shown in FIG. 17. The transfer supporting apparatus 200 has map information and grasps its own position and the position of the bed 410. Thus, the transfer supporting apparatus 200 can automatically move to the first position P1. Subsequently, the movement paths r1 are set from the first position P1 toward a position where the first and second supporting members 201a, 201b are inserted below the care recipient 402. At this time, the movement paths r1 of the first and second supporting members 201a, 201b are set so that one supporting member 201b, 201a is inserted below the vicinity of the should blades of the back of the care recipient 402 and the other supporting member 201a, 201b is inserted below the vicinity of the backs of the knees of the care recipient 402. In this embodiment, smooth paths are set so that the distance between the first and second supporting members 201a, 201b gradually reaches a specified distance upon the insertion below the care recipient 402 as the first and second supporting members 201a, 201b respectively approach the care recipient 402.

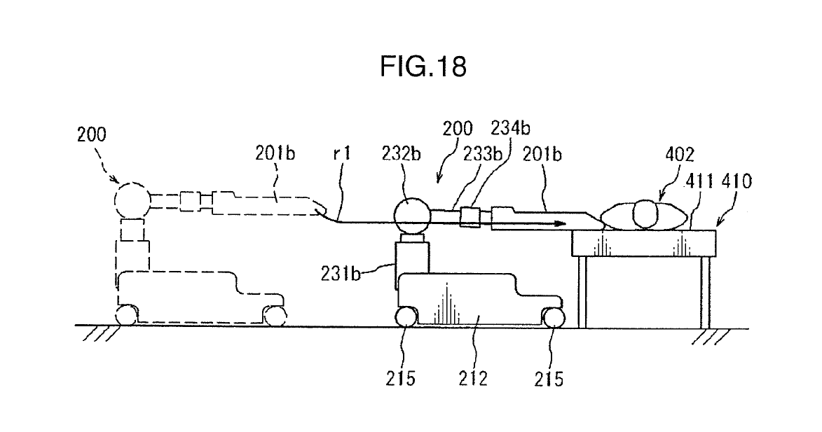

In this embodiment, the transfer supporting apparatus 200 includes the first detectors 361 for detecting the distance between the transfer supporting apparatus 200 and the bed 410 and the second detectors 362 for detecting the placing surface 411 of the bed 410 as shown in FIG. 15. The movement path setting unit 311 of the controller 310 sets the movement paths r1 of the supporting members (201a, 201b) so that the supporting members (201a, 201b) approach the height of the placing surface 411 of the bed 410 as the distance between the transfer supporting apparatus 200 and the bed 410 becomes shorter as shown in FIG. 18 based on the distance between the transfer supporting apparatus 200 and the bed 410 detected by the first detectors 361 and the placing surface 411 of the bed 410 detected by the second detectors 362.

In this embodiment, the smooth paths are set so that the supporting members (201a, 201b) reach a height slightly higher than the placing surface 411 (5 cm from the placing surface 411 in this embodiment) before reaching a position at a specified distance (50 cm in this embodiment) from the bed 410 when the supporting members (201a, 201b) approach the bed 410 on which the care recipient 402 is lying as shown in FIG. 18. By operating the supporting members (201a, 201b) along such paths r1, sudden descending movements of the supporting members (201a, 201b) immediately before the care recipient 402 can be prevented. In this way, sudden descents of the supporting members (201a, 201b) immediately before the care recipient 402 can be prevented, whereby anxiety or insecurity the care recipient 402 could feel can be reduced.

Next, the correction of the operation is described.

In this embodiment, the controller 310 includes the operation correcting unit 312. The operation correcting unit 312 corrects the movement of the supporting member 201 based on the operation of the operating units 202 by driving the actuators (301a, 301b to 305a, 305b) so that the supporting member 201 moves along the movement paths r1 set by the movement path setting unit 311.

In this embodiment, the movement paths of the first and second supporting members 201a, 201b are respectively set by the movement path setting unit 311 so that the one supporting member 201b, 201a is inserted below the vicinity of the should blades of the back of the care recipient 402 and the other supporting member 201a, 201b is inserted below the vicinity of the backs of the knees of the care recipient 402. This transfer supporting apparatus 200 is operated by the caregiver 401 as shown in FIG. 13. At this time, as shown in FIGS. 17 and 18, the operation by the caregiver 401 is corrected so that the supporting member 201 moves along the movement paths r1 set by the movement path setting unit 311. In other words, the controller 310 corrects the operation by the caregiver 401 by appropriately driving the actuators (301a, 301b to 305a, 305b). In this embodiment, the controller 310 corrects the operation by the caregiver 401 so that the first and second supporting members 201a, 201b do not largely deviate from the movement paths set by the movement path setting unit 311 by the operation by the caregiver 401.

In order to realize such a correction, the controller 310 includes the virtual potential energy setting unit 313 in this embodiment. The virtual potential energy setting unit 313 sets virtual potential energies for specifying the magnitudes of forces to be exerted to the supporting member 201. In this embodiment, the virtual potential energies determine the magnitudes of forces to be exerted to the supporting member 201 so as to bring the supporting member 201 closer to the movement paths r1 as the supporting member 201 moves away from the movement paths r1 based on the movement paths r1 set by the movement path setting unit 311. In other words, the forces to be exerted to the supporting member 201 have magnitudes corresponding to the distances from the movement paths r1 to the supporting member 201.

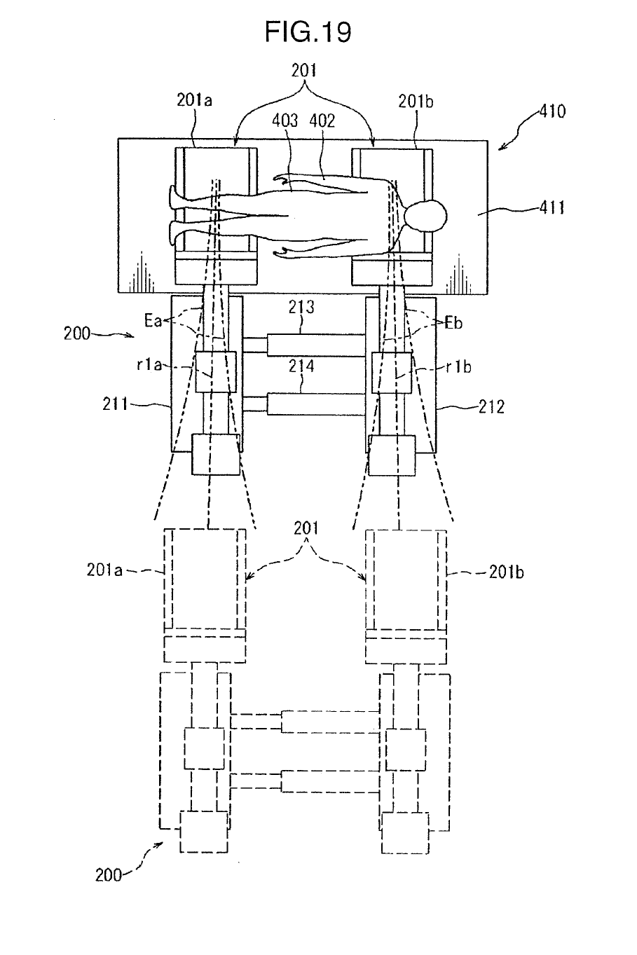

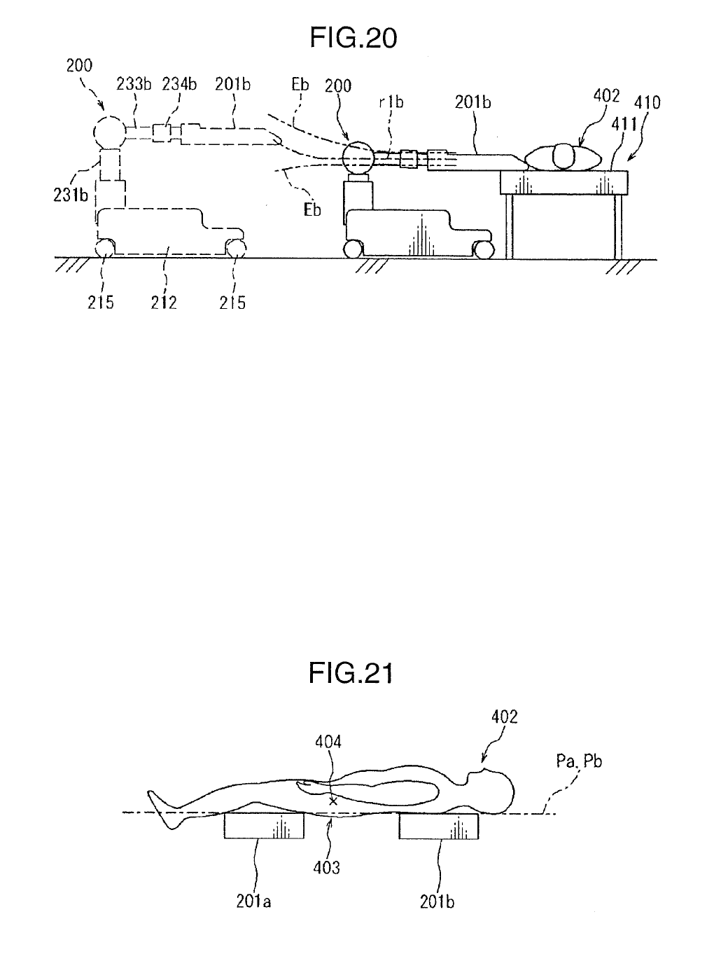

In this embodiment, the movement path r1a for the movement of the first supporting member 201a and the movement path r1b for the movement of the second supporting member 201b are respectively set in the movement path setting unit 311 as shown in FIGS. 19 and 20. Virtual potential energies Ea, Eb are respectively set for these movement paths r1a, r1b.

The operation correcting unit 312 causes forces to be exerted to the supporting member 201 to bring the supporting member 201 closer to the movement paths r1 by driving the actuators (301a, 301b to 305a, 305b) based on the virtual potential energies Ea, Eb set by the virtual potential energy setting unit 313. In this way, the movements of the supporting members 201a, 201b based on the operation of the operation levers 202a, 202b are corrected.

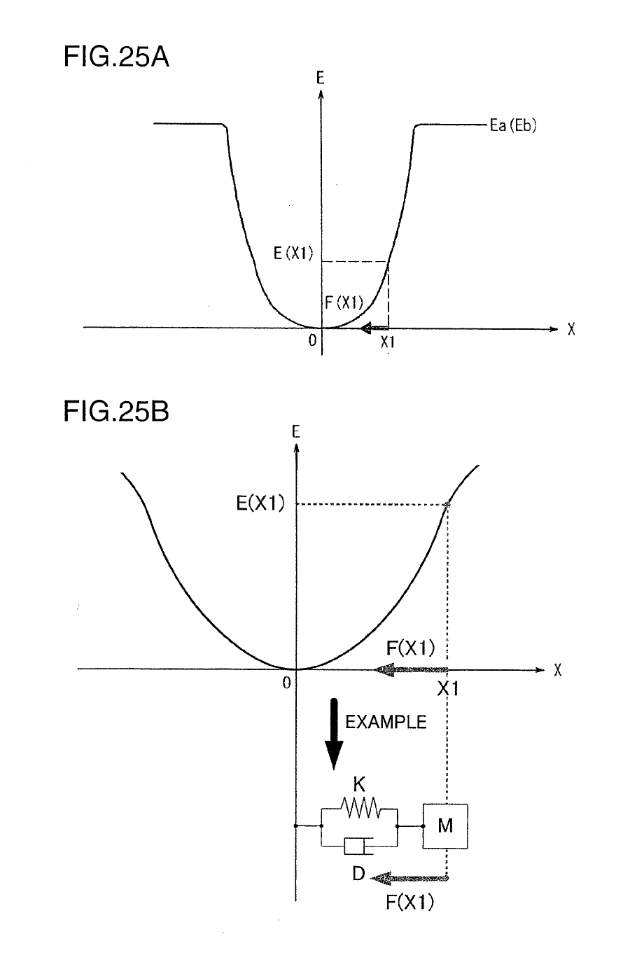

In this embodiment, a virtual energy field is set as the virtual potential energies Ea, Eb, for example, as shown in FIG. 25A. Specifically, in FIG. 25A, a horizontal axis represents a displacement amount x corresponding to a deviation amount from the movement path r1 and a vertical axis represents energy E. With the virtual potential energy Ea (Eb) shown in FIG. 25A, the force to be exerted to the supporting member 201a is 0 with the supporting member 201a located on the movement path r1 since the displacement amount x of the supporting member 201a is 0. On the other hand, if the supporting member 201a is displaced to a position x1 in FIG. 25A, virtual potential energy E(x1) is set. The virtual potential energy is set to gradually increase as the displacement amount x from the movement path r1 increases. In this case, according to the virtual potential energy E(x1), a force F(x1) to be exerted to the supporting member 201a is obtained. In this embodiment, F(x1) is calculated to be a force of a direction and a magnitude corresponding to an energy state at the position x1 of the virtual potential energy Ea (Eb) shown in FIG. 25A. Accordingly, as the supporting member 201a is largely displaced from the movement path r1, a force for returning the supporting member 201a to the movement path r1 increases. This force F(x1) can be calculated using the following equation (1) expressing a virtual model of a spring-mass-damper system, for example, as shown in FIG. 25B. The controller 310 causes the calculated force F(x1) to be exerted to the supporting member 201.

F(X1)=M\ddot{X}1+D\dot{X}1+KX1 (1)

where

M: apparent inertia term

D: apparent damping term

K: apparent stiffness term

\ddot{X}1: second-order derivative of X1 (acceleration)

\dot{X}1: first-order derivative of X1 (speed)

In this embodiment, the virtual potential energies Ea, Eb are set to narrow displaceable ranges where the movements of the supporting members 201a, 201b with respect to the movement paths r1a, r1b of the supporting members 201a, 201b are permitted as the transfer supporting apparatus 200 approaches the bed 410 as shown in FIGS. 19 and 20. The virtual potential energy setting unit 313 sets such virtual potential energies Ea, Eb based on the distance between the transfer supporting apparatus 200 and the bed 410 detected by the first detectors 361. In FIGS. 19 and 20, widths within which the movements of the first and second supporting members 201a, 201b are permitted by the virtual potential energies set by the virtual potential energy setting unit 313 are shown as lines Ea, Eb indicating the virtual potential energies for the sake of convenience.

Specifically, in this embodiment, the widths of the virtual potential energies Ea, Eb set by the virtual potential energy setting unit 313 become narrower as the distance between the transfer supporting apparatus 200 and the bed 410 becomes shorter as shown in FIGS. 19 and 20. In other words, the virtual potential energies Ea, Eb are set to narrow the widths within which the operations of the supporting members 201a, 201b are permitted as the transfer supporting apparatus 200 approaches the bed 410. Thus, the operation is corrected to bring the supporting member 201 closer to the movement paths r1a, r1b as the transfer supporting apparatus 200 approaches the bed 410.

In this embodiment, the widths of the virtual potential energies Ea, Eb are wide and a degree of freedom in the movement of the supporting member 201 by the caregiver 401 is large with the supporting member 201 held distant from the bed 410. In contrast, as the supporting member 201 approaches the bed 410, the widths of the virtual potential energies Ea, Eb become narrower, whereby the degree of freedom in the movement of the supporting member 201 by the caregiver 401 becomes gradually smaller. In this way, the first and second supporting members 201a, 201b are moved substantially on the movement paths r1a, r1b immediately before the supporting member 201 reaches the care recipient 402.

The controller 310 may have a warning function. In other words, even if the operations by the operation levers 202a, 202b are corrected by the operation correcting unit, the movements of the supporting members 201a, 201b may not comply with the operations by the operation levers 202a, 202b. Thus, a display may be displayed on a display unit or an audio guide may be given to let such a state understandable.

In this embodiment, the controller 310 includes the physique information storage 321 for storing the physique information of the care recipient 402. The virtual potential energy setting unit 313 sets virtual potential energies corresponding to the physique of a person based on the physique information stored in the physique information storage 321. For example, displacement widths xa, xb within which the movements of the supporting members 201a, 201b with respect to the movement paths r1a, r1b of the supporting members 201a, 201b are permitted are narrower in the case of a short care recipient 402b than in the case of a tall care recipient 402a as shown in FIG. 26.

In this embodiment, the controller 310 executes such a control as to maintain the position of the supporting member 201 if no input is made to operating units 202 to move the supporting member 201. In other words, in this embodiment, if there is no operation input signal from the operation levers 202a, 202b as shown in FIG. 14, the controller 310 performs a process for maintaining the position of the supporting member 201 in accordance with a program set beforehand. As the process for maintaining the position of the supporting member 201, the actuators (301a, 301b to 305a to 305b) are driven to exert forces to the supporting member 201 so as to maintain the position of the supporting member 201 in this embodiment if there is no operation input signal from the operations levers 202a, 202b. Thus, the position of the supporting member 201 is maintained if there is no operation input signal from the operation levers 202a, 202b. As the process for maintaining the position of the supporting member 201, a locking mechanism for locking the position of the supporting member 201 (e.g. brakes provided in the respective mechanisms) may be actuated. In this way, the supporting member 201 stops if the caregiver 401 releases his hands from the operation levers 202a, 202b, wherefore there is no contingency that the supporting member 201 makes.

In this embodiment, the controller 310 includes the correction canceling unit 325 for canceling the function of the operation correcting unit 312 as shown in FIG. 14. The correction canceling unit 325 is a controlling section for enabling the caregiver 401 (operator) to appropriately cancel the function of the operation correcting unit 312. In this embodiment, the correction canceling unit 325 is constructed such that the caregiver 401 (operator) can appropriately cancel the function of the operation correcting unit 312 by pressing a cancel button 371 as shown in FIG. 14. Such a cancel button 371 may be provided near the operation levers 202a, 202b. If the cancel button 371 is pressed, the correction canceling unit 325 functions in the controller 310 to cancel the function of the operation correcting unit 312. Thus, the forces of the actuators (301a, 301b to 305a, 305b) based on the above virtual potential energies Ea, Eb (see FIGS. 19 and 20) are canceled. In this way, the restraint of the supporting member 201 by the virtual potential energies Ea, Eb is released and the caregiver 401 (operator) can freely operate the supporting member 201.

Such a correction canceling unit 325 can appropriately cancel the function of the operation correcting unit 312, for example, if the caregiver 401 cannot properly move the supporting member 201 due to the function of the operation correcting unit 312. In this way, the caregiver 401 skilled in the operation of this transfer supporting apparatus 200 can also freely operate the supporting member 201.

In this embodiment, the controller 310 includes the movement path correcting unit 326 for correcting the movement paths r1a, r1b (see FIGS. 19 and 20) set by the movement path setting unit 311 as shown in FIG. 14. The movement path correcting unit 326 is, for example, a controlling unit for enabling the caregiver 401 (operator) to appropriately set proper movement paths. In this embodiment, the movement path correcting unit 326 includes a manual setting unit 372 for enabling the caregiver 401 to manually set movement paths in order to correct the movement paths set by the movement path setting unit 311. Such a movement path correcting unit 326 permits the caregiver 401 to make a correction if the movement paths automatically set in the transfer supporting apparatus 200 are desired to be appropriately corrected, for example, when the caregiver 401 skilled in the operation of the transfer supporting apparatus 200 operates. Thus, the caregiver 401 can freely set the movement path of the supporting member 201.

The operation correcting unit 312 corrects the movement of the supporting member 201 to move the supporting member 201 along the corrected movement paths if the movement paths r1a, r1b are corrected by the movement path correcting unit 326. In other words, the operation correcting unit 312 corrects the movement of the supporting member 201 based on the operation of the operating units 202 by driving the actuators (301a, 301b to 305a, 305b) so that the supporting member 201 moves along the movement paths corrected by the movement path correcting unit 326. According to this transfer supporting apparatus 200, the operation correcting unit 312 corrects the movement of the supporting member 201 based on the operation of the operation levers 202a, 202b so that the supporting member 201 moves along the movement paths set by the caregiver 401. Thus, the transfer supporting apparatus 200 can operate according to the intention of the caregiver 401. For example, in the case of finding an obstacle or the like hindering the movement of the transfer supporting apparatus 200 on the movement paths set by the controller 310, the operator (caregiver 401) can appropriately correct the movement paths set by the controller 310.

The operations and functions of this transfer supporting apparatus 200 are described below.

As shown in FIGS. 17 and 18, the movement paths r1 of the supporting members (201a, 201b) are set by the controller 310 (movement path setting unit 311) in this transfer supporting apparatus 200. The controller 310 (operation correcting unit 312) drives the actuators 301a, 301b to 305a, 305b to move the supporting member 201 along the movement paths r1. In this way, the transfer supporting apparatus 200 approaches the bed 410 while correcting the movements of the supporting members 201a, 201b based on the operation of the operating units 202.

Next, the supporting member 201 is inserted between the bed 410 and the care recipient 402. In this embodiment, the transfer supporting apparatus 200 includes the pressure sensors 363 in the supporting member 201. The pressure sensors 363 detect contact pressures between the placing surface 411 of the bed 410, on which the care recipient 402 is lying, and the supporting member 201. The operation correcting unit 312 corrects the movement of the supporting member 201 so that the detected contact pressures do not exceed a contact pressure predetermined in the controller 310. Thus, the supporting member 201 doesn't press in excess the bed upon inserting the supporting member 201 between the bed 410 and the care recipient 402. The controller 310 may store the specified contact pressure beforehand for such a movement correction. Further, a setting unit for enabling the operator to set such a contact pressure beforehand may also be provided.

In this embodiment, the care recipient 402 is placed on the hand units 222a, 222b at the leading ends of the supporting member 201 in the transfer supporting apparatus 200.

In this embodiment, the hand units 222a, 222b have a flat shape and the conveyor belts 241a, 241b are exposed from the leading ends of the hand units 222a, 222b to the upper surfaces thereof. The hand units 222a, 222b include the fifth drivers 305a, 305b for moving the conveyor belts 241a, 241b. Thus, the care recipient 402 can be easily placed on the hand units 222a, 222b by inserting the leading ends of the hand units 222a, 222b below the care recipient 402 and moving the conveyor belts 241a, 241b.

In this embodiment, the controllers 310 reverses the movements of the conveyor belts 241a, 241b in synchronism with the inserting operation upon inserting the hand units 222a, 222b between the care recipient 402 and the bed 410. In this way, the supporting member 201 can be smoothly inserted between the bed 410 and the care recipient 402. This enables a relative speed of the contact surfaces of the hand units 222a, 222b and that of the care recipient 402 to be zeroed upon inserting the hand units 222a, 222b between the care recipient 402 and the bed 410. In this way, there is almost no friction between the hand units 222a, 222b and the care recipient 402 upon inserting the hand units 222a, 222b between the care recipient 402 and the bed 410, wherefore the burden of the care recipient 402 can be reduced.

In this embodiment, the controller 310 strongly restrains the movements of the hand units 222a, 222b by forces to be exerted according to the virtual potential energies so as to prevent the hand units 222a, 222b from being moved in vertical direction and lateral direction or inclined, so that the hand units 222a, 222b are inserted straight with respect to the care recipient 402 upon being inserted between the care recipient 402 and the bed 410 as described above. In this way, the hand units 222a, 222b are inserted straight with respect to the care recipient 402. This point similarly holds for the operation of pulling out the hand units 222a, 222b from below the care recipient 402 (fifth step).

Next, the second step of lifting up the care recipient is described.

The controller 310 includes the permissible bending angle setting unit 323 and the bending angle calculating unit 324. In this embodiment, the permissible bending angle setting unit 323 sets a permissible bending angle of the hip joint 404 of the care recipient 402 in the operation of lifting up the care recipient 402 while supporting him by the first and second supporting members 201a, 201b (lift-up operation).

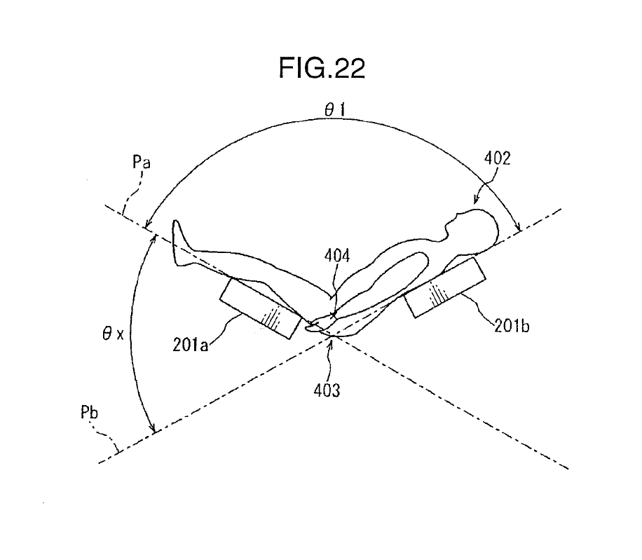

Here, the “bending angle of the hip joint” is a forward inclined angle of the upper body at the hip joint as shown in FIG. 22. As shown in FIGS. 21 and 22, a bending angle θx of the hip joint 404 of the care recipient 402 is presumed to be a bending angle of the hip joint 404 of the care recipient 402 lifted up by the first and second supporting members 201a, 201b for the sake of convenience. In this embodiment, the permissible bending angle setting unit 323 sets the permissible bending angle of the hip joint 404 in this lift-up operation beforehand and sets such that the bending angle θx of the hip joint 404 of the care recipient 402 satisfies a relationship of 0°≦θx≦30° in this lift-up operation.

The bending angle calculating unit 324 calculates the bending angle of the hip joint 404 of the care recipient 402 lifted up by the first and second supporting members 201a, 201b. In this embodiment, the first and second supporting members 201a, 201b support the upper and lower bodies of the care recipient 402 by the flat hand units 222a, 222b. The bending angle calculating unit 324 calculates the bending angle θx of the hip joint 404 of the care recipient 402 lifted up by the first and second supporting members 201a, 201b by subtracting an angle θ1 between flat surfaces Pa, Pb of the hand units 222a, 222b of the first and second supporting members 201a, 201b from 180°. In other words, the bending angle θx is calculated by θx=180−θ1.

The controller corrects the movement of the supporting member 201 based on the operation of the operating units 202 so that the bending angle calculated by the bending angle calculating unit 324 lies in the range of the permissible bending angle set by the permissible bending angle setting unit 323 in the lift-up operation by the first and second supporting members 201a, 201b. In this embodiment, the permissible bending angle is, for example, set to 30° in the permissible bending angle setting unit 323. Thus, the operation correcting unit 312 corrects the movements of the supporting members 201a, 201b based on the operation of the operating units 202 so that the bending angle θx of the hip joint 404 of the care recipient 402 lifted up by the first and second supporting members 201a, 201b satisfies the relationship of 0°≦θx≦30°.

Specifically, in this embodiment, the controller 310 corrects the movements of the supporting members 201a, 201b based on the operation of the operating units 202 by driving the actuators 301a, 301b to 305a, 305b. In order to realize such a correction, the controller 310 sets the virtual potential energies for specifying the magnitudes of forces to be exerted to the supporting members 201a, 201b in the virtual potential energy setting unit 313 in this embodiment.

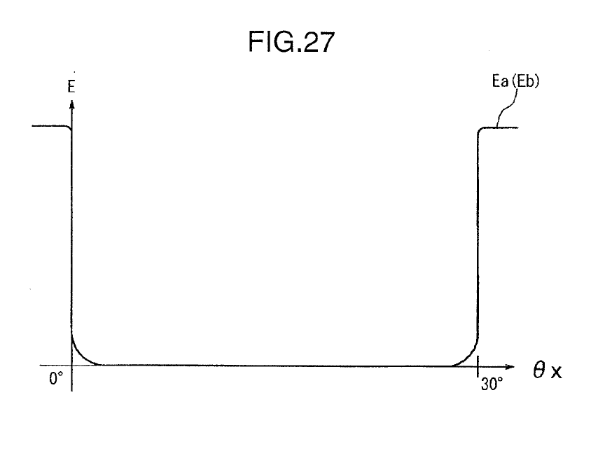

In this embodiment, the virtual potential energies restrict the movements of the supporting members 201a, 201b so that the bending angle θx no longer increases upon the approach to the permissible bending angle (30° in this embodiment) set by the permissible bending angle setting unit 323. In other words, in this embodiment, the virtual potential energies Ea, Eb for specifying the magnitudes of the forces to be exerted to the supporting members 201a, 201b are set for the bending angle θx as shown in FIG. 27. If the virtual potential energies Ea, Eb are set as shown in FIG. 27, the forces to be exerted to the supporting members 201a, 20b are small in the range of 0°≦θx≦30° except when the bending angle θx is at and near 0° and 30°. At and near 0° and 30°, the virtual potential energies Ea, Eb gradually increase lest the bending angle θx should become smaller than 0° or larger than 30°.

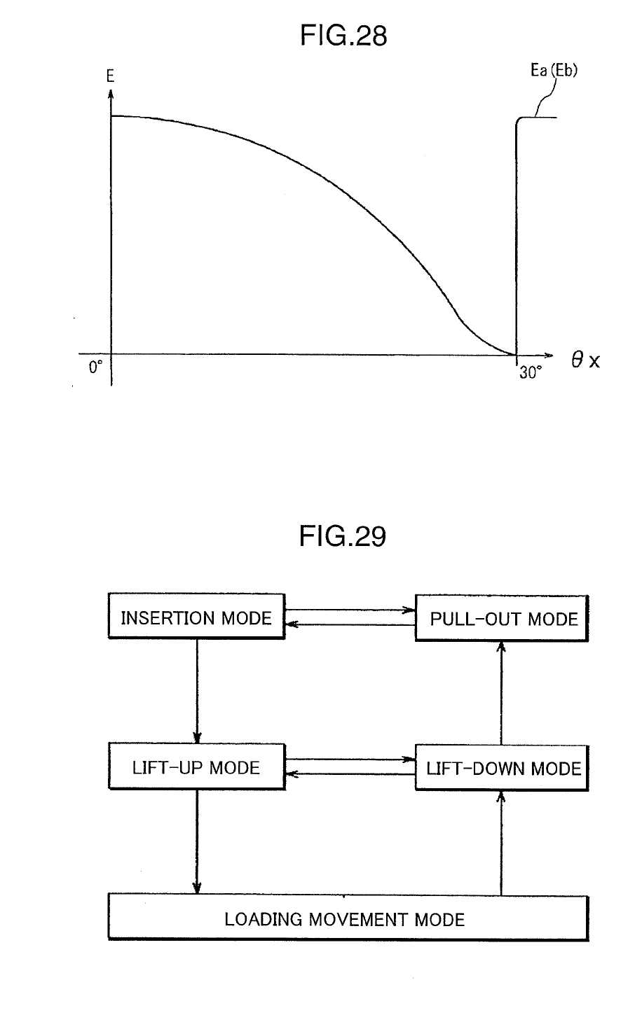

Next, a case is described where the supporting members 201a, 201b are operated so that the bending angle θx reaches 30° from a bending angle smaller than 30° without exceeding 30°. In this case, the virtual potential energies Ea, Eb may be set as shown in FIG. 28. If the virtual potential energies Ea, Eb are set as shown in FIG. 28, forces are exerted to the supporting members 201a, 201b so that the bending angle θx approaches 30° from a bending angle smaller than 30°. If the bending angle θx exceeds 30°, the virtual potential energies Ea, Eb suddenly increase, whereby large reaction forces act in response to such an operation that the bending angle θx exceeds 30°, thereby restricting such an operation.

Thus, in this embodiment, the controller 310 drives the actuators 301a, 301b to 305a, 305b lest the bending angle of the hip joint 404 of the care recipient 402 should exceed the permissible bending angle set by the permissible bending angle setting unit 323 when the bending angle approaches the permissible bending angle. At this time, the bending angle is prevented from exceeding the permissible bending angle by increasing forces for correcting the movements of the supporting members 201a, 201b based on the operation of the operating units 202.

In this way, the movements of the supporting members 201a, 201b are restricted lest the bending angle of the hip joint 404 of the care recipient 402 should exceed the permissible bending angle. In other words, it can be prevented by the action of the virtual potential energies that the bending angle θx of the hip joint 404 of the care recipient 402 becomes smaller than 0° and the back of the care recipient 402 is warped as shown in FIG. 21. Further, it can be prevented that the bending angle θx of the hip joint 404 of the care recipient 402 exceeds 30° to compress the abdomen of the care recipient 402 as shown in FIG. 22. Although 0° and 30° are set as lower and upper limits of the permissible bending angle in this embodiment, the permissible bending angle is not limited to this range. In this embodiment, the permissible bending angle can be appropriately set to a suitable angle in the permissible bending angle setting unit 323.

In this embodiment, in the second step, the controller 310 controls the lift-up operation with the care recipient 402 supported by the first and second supporting members 201a, 201b as shown in FIGS. 21 and 22. In this operation, the controller 310 links the movements of the first and second supporting members 201a, 201b in the height direction and the bending movement of the hip joint 404 of the care recipient 402. In other words, in the operation of lifting up the care recipient 402, the first and second supporting members 201a, 201b are gradually rotated as the lift-up height of the care recipient 402 increases, whereby the hip joint 404 of the care recipient 402 is gradually bent to reach a proper bending angle.

As described above, according to this transfer supporting apparatus 200, the hip joint 404 of the care recipient 402 can be bent according to the lift-up height of the care recipient 402 by the first and second supporting members 201, 201b. Thus, the care recipient 402 can be lifted in such a posture comfortable to him. In the fourth step of lowering the care recipient, a downward movement upon lowering the care recipient 402 by the first and second supporting members 201a, 201b and a straightening movement of the hip joint 404 of the care recipient 402 may be linked.

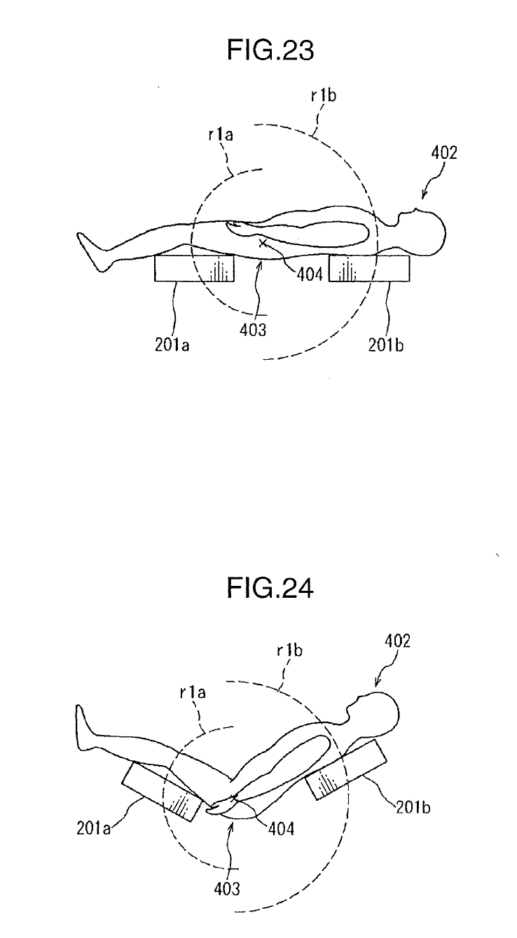

In this embodiment, the controller 310 sets the movement paths r1a, r1b of the first and second supporting members 201a, 201b so that the positions of the first and second supporting members 201a, 201b supporting the care recipient 402 do not change with respect to the care recipient 402 in the operation of lifting up the care recipient 402 by the first and second supporting members 201a, 201b as shown in FIGS. 23 and 24.

Specifically, in this embodiment, the controller 310 includes the hip joint specifying unit 327 for specifying the position of the hip joint 404 of the care recipient 402 supported by the supporting members 201a, 201b as shown in FIGS. 23 and 24. In this embodiment, the hip joint specifying unit 327 specifies the position of the hip joint 404 of the care recipient 402 by a program determined beforehand, for example, based on the physique information (e.g. height information, weight information) stored in the physique information storage 321.

The controller 310 sets the movement paths r1a, r1b of the first and second supporting members 201a, 201b based on the position of the hip joint 404 of the care recipient 402 specified by the hip joint specifying unit 327 in the operation of bending the care recipient 402 supported by the supporting members 201a, 201b. In this embodiment, the hip joint specifying unit 327 of the controller 310 specifies the position of the hip joint 404 of the care recipient 402 as shown in FIGS. 23 and 24 and the movement path setting unit 311 sets the movement paths r1a, r1b of the first and second supporting members 201a, 201b. In this embodiment, the movement paths r1a, r1b of the first and second supporting members 201a, 201b are respectively set to be arcuate about the position of the hip joint 404 of the care recipient 402 with respect to the position of the hip joint 404 of the care recipient 402. In other words, the movement paths of the first and second supporting members 201a, 201b are respectively set so that the first and second supporting members 201a, 201b move while being held at specified distances from the position of the hip joint 404 with the supporting members 201a, 201b supporting the care recipient 402 held in contact with the body of the care recipient 402.

In this embodiment, the controller 310 rotates the hand units 222a, 222b about the longitudinal axes of the second arms 233a, 233b so as to hold the hand units 222a, 222b and the care recipient 402 in contact in the operation of bending the care recipient 402.

Specifically, in this embodiment, the hand units 222a, 222b include the detection sensors 365 (proximity sensors 366 and pressure sensors 367) for detecting whether or not the hand units 222a, 222b are supporting a person as shown in FIG. 12. The controller 310 detects the contact states of the hand units 222a, 222b with the back and the backs of the knees of the care recipient 402 using the detection sensors 365. In the operation of bending the care recipient 402, the controller 310 changes the angles of rotation of the hand units 222a, 222b so as to maintain these contact states while performing the above detection. In this way, the hand units 222a, 222b and the care recipient 402 are kept in contact in the operation of bending the care recipient 402. Thus, upon bending the care recipient 402, displacements and frictions of the hand units 222a, 222b and the care recipient 402 can be suppressed to low levels.

In this embodiment, the controller 310 strongly restrains the movements of the hand units 222a, 222b by the virtual potential energies so that the hand units 222a, 222b properly move along the set movement paths in the operation of lifting up the care recipient 402 as described above. Thus, the hand units 222a, 222b can be properly operated with respect to the care recipient 402 so as not to burden the care recipient 402. This point similarly holds in the operation of lowering the care recipient 402 (fourth step).

The controller 310 corrects the movement of the supporting member 201 based on the operation of the operating units 202 lest the care recipient 402 supported by the first and second supporting members 201a, 201b should come into contact with any obstacle in the third step of moving the care recipient 402 while lifting him up. In this embodiment, the controller 310 includes the obstacle detecting unit 342 for detecting any obstacle on the movement path as shown in FIG. 14. The controller 310 sets the movement paths of the first and second supporting members 201a, 201b lest the care recipient 402 supported by the first and second supporting members 201a, 201b should come into contact with the obstacle detected by the obstacle detecting unit 342.

Specifically, in this embodiment, the controller 310 includes the posture information storage 328. The posture information storage 328 stores information on the posture of the care recipient 402 supported by the supporting members 201a, 201b. Information on the posture of the care recipient 402 supported by the supporting members 201a, 201b is input by the operator (caregiver 402), for example, using a posture operating unit (not shown) provided near the operating units 202. For example, the operator (caregiver 4021) may see the posture of the care recipient 402 supported by the supporting members 201a, 201b to input information on the posture of the care recipient 402 such as information as to which of left and right sides the head of the care recipient 402 is facing.

The controller 310 (movement path setting unit) sets the movement paths along which the supporting members 201a, 201b are moved so that the head of the care recipient 402 is located higher than the feet thereof based on the information on the posture of the care recipient 402 stored in the posture information storage 328 with the care recipient 402 supported by the supporting members 201a, 201b. In this embodiment, the controller 310 can roughly recognize the posture of the care recipient 402 (specifically, the position of the head of the care recipient 402, the positions of the feet, etc.) by a predetermined program based on the physique information (e.g. height information and weight information) stored in the physique information storage 321 and the positions and postures of the supporting members 201a, 201b. Thus, upon setting the movement paths, proper movement paths can be set so that the care recipient 402 does not come into contact with an obstacle detected by the obstacle detecting unit 342.

The controller 310 corrects the movement of the supporting member 201 based on the operation of the operating units 202 by driving the actuators (301a, 301b to 305a, 305b) so that the supporting members 201a, 201b move along the set movement paths.

In this way, the first and second supporting members 201a, 201b can be easily moved such that the care recipient 402 does not come into contact with the obstacle detected by the obstacle detecting unit 342 even with the care recipient 402 supported by the supporting members 201a, 201b.

In this embodiment, the controller 310 strongly restrains the operation of the hand units 222a, 222b by the virtual potential energies so that the hand units 222a, 222b properly move along the set movement paths in the operation of moving the lifted-up care recipient 402 as described above. Particularly, the operation of the hand units 222a, 222b is strongly restrained by the virtual potential energies with respect to the distance between the left and right hand units 222a, 222b and the inclination of the left and right hand units 222a, 222b. In this way, it is possible to prevent the posture of the care recipient 402 from becoming unstable.

Subsequently, in the fourth step of lowering the care recipient, the transfer supporting apparatus 200 restricts the moving speed of the supporting member 201 such that the hand units 222a, 222b slowly move (do not move quickly) upon coming closer to the bed 410 than a specified distance.

Specifically, in this embodiment, the transfer supporting apparatus 200 includes the first detectors 361 for detecting the distance between the transfer supporting apparatus 200 and the bed 410 and the second detectors 362 for detecting the height of the supporting member 201 with respect to the placing surface 411 of the bed 410 as shown in FIG. 15. Based on the distance between the transfer supporting apparatus and the bed 410 detected by the first detectors 361, the controller 310 restricts the moving speed of the movable body 205 to a speed slower than a speed predetermined in the controller 310 so that the transfer supporting apparatus 200 slowly approaches when the transfer supporting apparatus 200 comes closer to the bed 410 than the distance predetermined in the controller 310. Further, based on the height of the supporting member 201 with respect to the placing surface 411 detected by the second detectors 362, the controller 310 restricts the moving speed of the supporting member 201 to a speed slower than a speed predetermined in the controller 310 so that the supporting member 201 slowly moves when the supporting member 201 comes closer to the bed 410 than a height predetermined in the controller 310.

In this way, for example, when the care recipient 402 is lowered to the bed 410, the hand units 222a, 222b slowly move when coming closer to the bed 410 and the care recipient 402 is slowly lowered to the bed 410. Thus, discomfort that could be felt by the care recipient 402 upon being lowered to the bed 410 is reduced. Since the hand units 222a, 222b slowly move upon approaching the bed 410, the operator (caregiver 401) can more easily operate the transfer supporting apparatus 200 and can easily move the hand units 222a, 222b to proper positions with respect to the bed 410.

Subsequently, in the fifth step of pulling out the supporting member 201 (hand units 222a, 222b), the care recipient 402 may be transferred onto the bed 410 by the conveyor belts 241a, 241b equipped in the hand units 222a, 222b in this embodiment.

In this embodiment, an insertion mode (first step), a lift-up mode (second step), a loading movement mode (third step), a lift-down mode (fourth step) and a pull-out mode (fifth step) are respectively set in the controller 310 as shown in FIG. 29. The movement paths of the supporting members 201a, 201b are set in the respective modes. The movements of the supporting members 201a, 201b based on the operation of the operating units 202 are corrected by driving the actuators 301a, 301b to 305a, 305b so that the supporting members 201a, 201b move along the movement paths r1a, r1b.

In this embodiment, the insertion mode (first step), the lift-up mode (second step), the loading movement mode (third step), the lift-down mode (fourth step) and the pull-out mode (fifth step) are automatically switched as shown in FIG. 29.

For example, the controller 310 judges that the inserting operation has been completed and moves onto the lift-up mode (second step) if the operation input information for the lift-up operation is input by the operation levers 202a, 202b when the second detectors 362 detects the placement of the lower surfaces of the hand units 222a, 222b on the placing face 411 and the detection sensors 365 for detecting whether or not a person is being supported detect that a person is being supported in the insertion mode (first step). Subsequently, in the lift-up mode (second step), the lift-up operation is performed, it is judged that the lift-up operation has been completed and transition is made to the loading movement mode (third step) if the operation input information for the moving operation is input after reaching positions near the final ends of the paths generated in the lift-up mode. In the loading movement mode (third step), the moving operation is performed, it is judged that the moving operation has been completed and transition is made to the lift-down mode (fourth step) if the operation input information for the lift-down operation is input after reaching positions near the final ends of the paths generated in the loading movement mode. In the lift-down mode (fourth step), it is judged that the operation of lowering the care recipient 402 has been completed and transition is made to the pull-out mode (fifth step) when the second detectors 362 detect the placement of the lower surfaces of the hand units 222a, 222b on the placing surface 411 and the operation input information for the pull-out operation is input. The controller 310 detects the completion of each operation in accordance with the preset program based on signals of various sensors of the transfer supporting apparatus 200.

If the respective modes are automatically performed in this way, the modes are smoothly switched to present good operability. The respective modes may be manually switched by the operator. In this case, the controller 310 checks whether or not the modes may be manually switched based on the various sensor signals of the transfer supporting apparatus 200. For example, in the case of manually switching from the lift-down mode (fourth step) to the pull-out mode (fifth step), manual transition to the pull-out mode (fifth step) is permitted only when the second detectors 362 detect placement of the lower surfaces of the hand units 222a, 222b on the placing surface 411. This can prevent the pull-out operation accompanying the rotation of the belts is performed despite a state where the lower surfaces of the hand units 222a, 222b are not placed on the placing surface 411. In other words, it can be prevented that the belts are erroneously rotated with a person lifted up, whereby the safety of the person can be ensured. Further, mutual transition between the insertion mode (first step) and the pull-out mode (fifth step) and between the lift-up mode (second step) and the lift-down mode (fourth step) may also be settable. This enables various operations to be redone while skipping some modes. For example, if it is desired to slightly lift down the care recipient at the time of the lift-up mode (second step), transition is made to the lift-down mode (fourth step) to directly proceed to the lift-down operation.

As described above, the controller 310 sets the movement paths r1a, r1b of the supporting members 201a, 201b in this transfer supporting apparatus 200. Further, the controller 310 corrects the movements of the supporting members 201a, 201b based on the operation of the operating units 202 by driving the actuators (301a, 301b to 305a, 305b) so that the supporting members 201a, 201b move along the movement paths r1a, r1b. Thus, even in the case of operation by an operator (caregiver 401) with a low skill in the operation of the transfer supporting apparatus 200, such an operation as to burden a person receiving the transfer support (care recipient 402), for example, by forcing the care recipient 402 to take an improper physical posture, since the operation of the caregiver 401 is corrected by the controller 310. Therefore, the operator (caregiver 401) can easily operate the transfer supporting apparatus 200 and the care recipient 402 receiving the transfer support can entrust himself to the operator's care.

The transfer supporting apparatus according to one embodiment of the present invention is described above, but the transfer supporting apparatus of the present invention is not limited to the above embodiment.

For example, the structure of the transfer supporting apparatus is not limited to the above structure. For example, in the above embodiment, the supporting member includes the first and second supporting members, one of which supports the upper body of a person and the other of which supports the lower body of the person. In the present invention, it is sufficient for the supporting member to be so structured as to be able to support a person and the structure of the supporting member is not limited to the above embodiment. The construction of the controller is also not limited to the above embodiment. Various characteristics in the above controls are realized in one transfer supporting apparatus.

A transfer supporting apparatus according to another embodiment of the present invention is described below.

### Another Embodiment

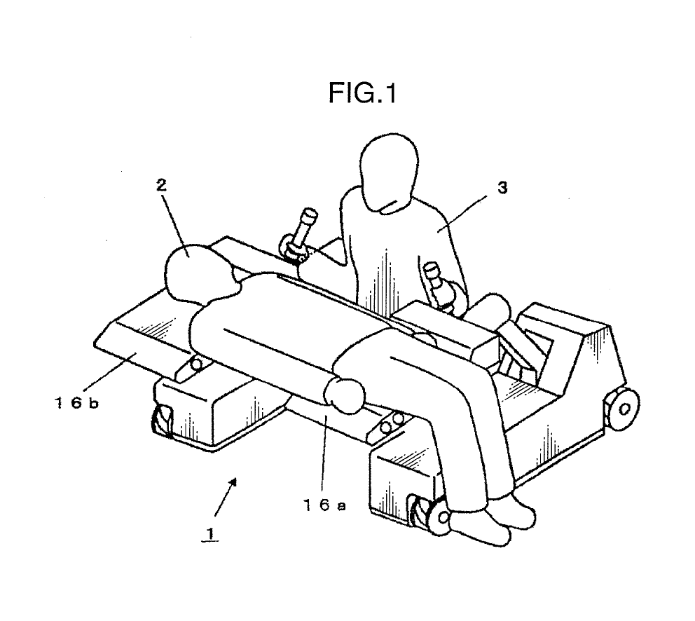

First of all, a case where a caregiver 3 cares a care recipient 2 using a transfer supporting apparatus 1 according to this embodiment is summarily described with reference to FIG. 1. FIG. 1 is a perspective view showing a used state of the transfer supporting apparatus 1. Here, a sick person, an injured person or the like is described as the care recipient.

As shown in FIG. 1, the transfer supporting apparatus 1 of this embodiment performs an operation of inserting left and right supporting members 16a, 16b between a placing tool and the care recipient 2 lying on the placing tool (inserting operation), an operation of lifting up the care recipient 2 onto supporting surfaces of the supporting members 16a, 16b (lift-up operation), an operation of moving the care recipient 2 in an arbitrary posture to a placing tool located at a different position (loading/moving operation), an operation of lowering the supporting members 16a, 16b to lower the care recipient onto the placing tool (lift-down operation) and an operation of pulling out the supporting members 16a, 16b from between the placing tool and the care recipient 2 (pull-out operation) as basic transfer operations. In this way, the caregiver 3 can transfer the care recipient 2 in an arbitrary posture to the other placing tool.

Upon performing these basic transfer operations, the caregiver 3 needs to perform operations comfortable to and imposing little burden on the care recipient 2.

Thus, the transfer supporting apparatus 1 of this embodiment is characterized by obtaining body information indicating features relating to the body of the care recipient 2 when the care recipient 2 lying on the placing tool is lifted up by the supporting members 16a, 16b and transferred to another placing tool, generating movement posture/path information for determining target positions and target postures of the supporting members 16a, 16b based on the body information when the care recipient 2 is held by the supporting members 16a, 16b, and supporting the supporting members 16a, 16b to reach the target positions and the target postures based on the movement posture information.

In this way, the transfer supporting apparatus 1 can perform operations comfortable to the care recipient 2 and can transfer the care recipient 2 in such a posture with little physical burden based on the body information of the care recipient 2 even if being operated by an operation with a low skill.

The transfer supporting apparatus 1 sets operation restriction based on the body information (physique information) of the care recipient 2 so as to avoid an extreme posture imposing an extreme burden on the care recipient 2, and the positions/postures of the supporting members 16a, 16b are controlled within the range of this operation restriction. For smooth operations within this operation restriction range, the concept of virtual potential energy is introduced for each position on the movement posture/path and the virtual potential energy is suddenly increased for a posture at a limit of the operation restriction as described later. In this way, the transfer supporting apparatus 1 executes a control to move the supporting members 16a, 16b toward sides where the virtual potential energies decrease within the operation restriction. Thus, the transfer supporting apparatus 1 can be provided which is safe and secure without imposing any burden on the care recipient 2. The transfer supporting apparatus 1 can be smoothly operated depending on the gradient of the virtual potential energy.

A case is described below where a person lying on a placing tool is lifted up and transferred to another placing tool using the left and right supporting members.

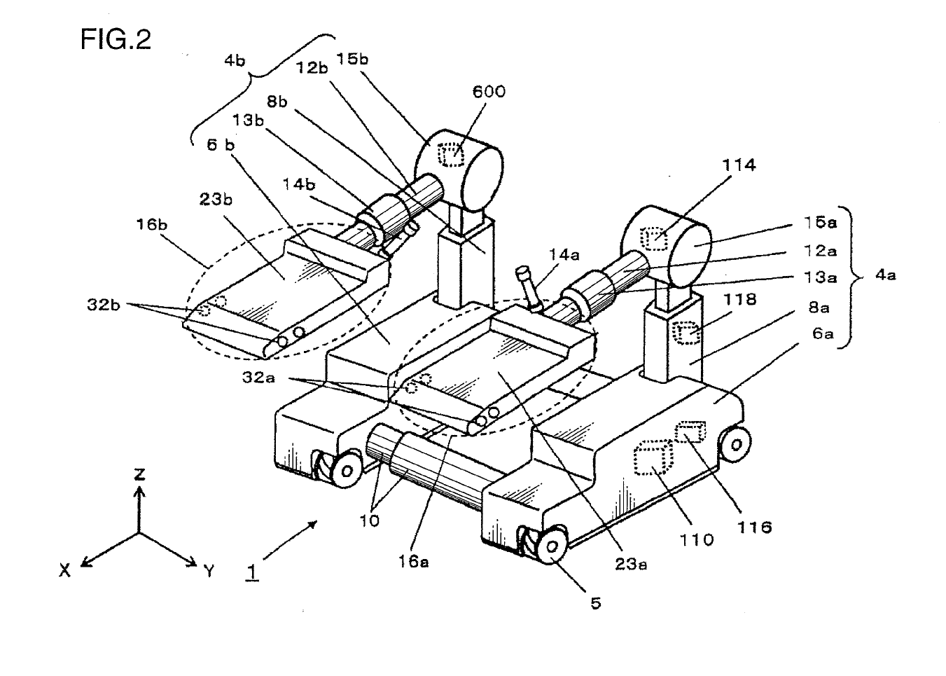

The structure of the transfer supporting apparatus 1 according to this embodiment is described next with reference to FIG. 2. FIG. 2 is a perspective view showing the structure of an essential part of the transfer supporting apparatus 1.

First of all, the construction of the transfer supporting apparatus 1 is described with reference to FIG. 2. In FIG. 2, three axes (X-axis, Y-axis and Z-axis) orthogonal to each other are defined such that an XY plane is a horizontal plane parallel to the ground surface and the front surface of the transfer supporting apparatus 1 is facing in an X-direction.

The transfer supporting apparatus 1 is provided with the left and right supporting members 16a, 16b, a body information obtaining section 600 for obtaining body information indicating features relating to the body of the care recipient 2, a controller 110 for generating movement control information for controlling target positions and target postures of the supporting members 16a, 16b (hereinafter, “movement posture/path information”) based on the body information when the care recipient 2 is held by the supporting members 16a, 16b, supporting portions 4a, 4b for supporting the supporting members 16a, 16b based on the movement posture/path information so that the supporting members 16a, 16b take the target positions and the target postures, and operating units 14a, 14b used to input instruction information for operating the supporting members 16a, 16b.

The supporting members 16a, 16b are arranged for the purpose of being inserted between the care recipient 2 lying on the placing tool and a placing surface of the placing tool to lift up the care recipient 2. The supporting members 16a, 16b include belts 23a, 23b (conveyor belts) for changing positions where the care recipient 2 lifted up by the supporting members 16a, 16b is supported, and placement detection sensors 32a, 32b (e.g. pressure sensors) as placement detectors for detecting the placement of the lower surfaces of the supporting members 16a, 16b on the upper surface of the placing surface of the placing tool.

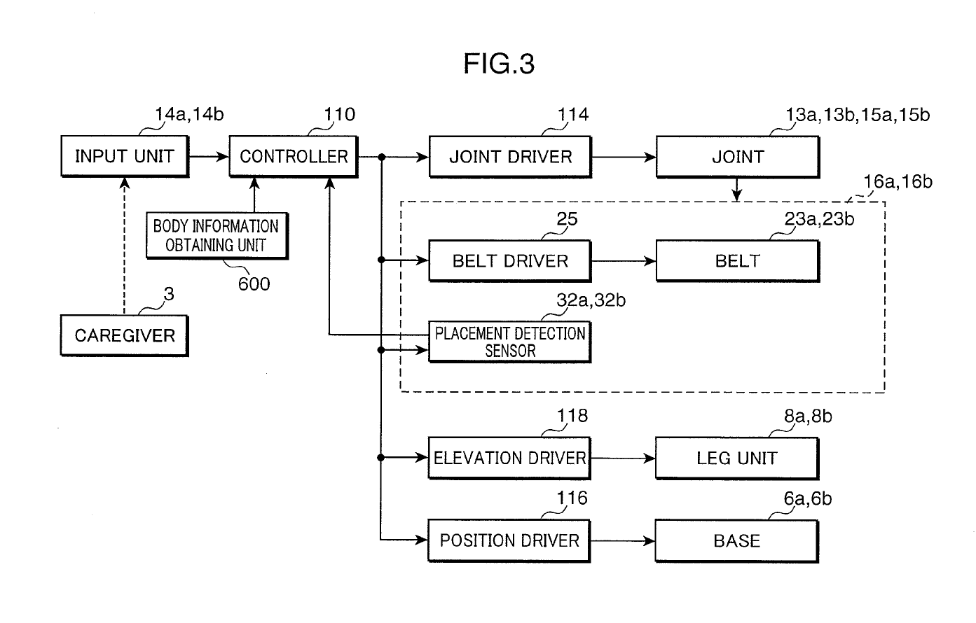

The belts 23a, 23b are driven to rotate by belt drivers 25 (FIG. 3) to be described later in synchronism with an operation of inserting or pulling out the supporting members 16a, 16b. In this way, relative speeds to the care recipient 2 at contact surfaces are zeroed, whereby displacements of the back surface of the care recipient 2 and the placing surface of the placing tool can be prevented. Here, it is assumed that the belt 23a relates to the supporting member 16a and the belt 23b relates to the supporting member 16b. The belts 23a, 23b are exposed at the upper surfaces of the supporting members 16a, 16b, wherefore the care recipient 2 can be moved while being placed on the belts 23a, 23b.

A plurality of placement detection sensors 32a, 32b are arranged near the opposite ends of the lower surfaces at the front sides of the supporting members 16a, 16b with respect to an inserting direction, wherein the placement detection sensors provided in the supporting member 16a are placement detection sensors 32a and those provided in the supporting members 16b are placement detection sensors 32b.

The supporting portions 4a, 4b include bases 6a, 6b as supporting member insertion means for inserting the supporting members 16a, 16b between the care recipient 2 and the placing surface of the placing tool, leg units 8a, 8b as elevation means for moving the supporting members 16a, 16b upward and downward, joints 13a, 13b, joints 15a, 15b and arms 12a, 12b for changing the postures of the supporting members 16a, 16b. Thus, the supporting portions 4a, 4b can support the supporting members 16a, 16b so that the supporting members 16a, 16b take the target positions and the target postures. Here, it is assumed that the supporting portion 4a relates to the supporting member 16a and the supporting member 4b relates to the supporting member 16b.

The joints 13a, 13b are provided as first rotation means for changing the postures of the supporting members 16a, 16b and rotate about the X-axis with respect to the supporting portions 4a, 4b as position/posture references. Here, it is assumed that the joint 13a rotates with respect to the supporting member 16a and the joint 13b rotates with respect to the supporting member 16b. Similarly, the joints 15a, 15b are provided as second rotation means for changing the postures of the supporting members 16a, 16b and rotate about the Y-axis with respect to the supporting portions 4a, 4b. Here, it is assumed that the joint 15a rotates with respect to the supporting member 16a and the joint 15b rotates with respect to the supporting member 16b. A known bearing mechanism rotatable in one axial direction can be used for each of the joints 13a, 13b, 15a and 15b, which are driven by joint drivers 114 using a motor or the like as a power source.

The arms 12a, 12b connect the joints 13a, 13b and the joints 15a, 15. Here, it is assumed that the arm 12a is connected with the joints 13a, 15a and the arm 12b is connected with the joints 13b, 15b. The arms 12a, 12b may have telescopic mechanisms, so that relative positions of the supporting members 16a, 16b can be changed by the extension/contraction of the arms 12a, 12b.

The bases 6a, 6b are fitted with a plurality of wheels 5. The wheels 5 are driven by positions drivers 116 using motors or the like as power sources and enable the entire transfer supporting apparatus 1 to autonomously move to front, rear, left and right sides, rotate about the Z-axis and change an absolute posture. Here, it is assumed the base 6a is located at the side corresponding to the supporting member 16a and the base 6b is located at the side corresponding to the supporting member 16b. The bases 6a, 6b are connected by coupling portions 10, which extend and contract in conformity with movements of the wheels 5 according to needs, thereby adjusting a distance between the supporting members 16a, 16b to change relative positions. A construction using both of the wheels 5 and the arms 12a, 12b and a construction using only the arms 12a, 12b may be employed as the supporting member insertion means. In the case of using only the arms 12a, 12b, the positions of the supporting members 16a, 16b are changed by the extension and contraction of the arms 12a, 12b.

The leg units 8a, 8b connect the bases 6a, 6b and the joints 15a, 15b and move the supporting members 16a, 16b upward and downward by sliding mechanisms. The sliding mechanisms are driven by elevation drivers 118 using motors or the like as power sources. Here, it is assumed that the leg unit 8a relates to the supporting member 16a and the leg unit 8b relates to the supporting member 16b. As another elevation means, a plurality of links may be combined and the supporting members 16a, 16b may be moved upward and downward to change the relative positions by changing angles of connected parts.

The body information obtaining unit 600 obtains the body information indicating the features relating to the body of the care recipient 2 by known obtaining means. For example, information manually input by the caregiver 3 may be obtained. Further, the information of the care recipient 2 managed by a wireless IC tag may be obtained. In another example, information may be obtained from an IC card managing the care recipient 2. The transfer supporting apparatus 1 can set optimal positions/postures of the supporting members 16a, 16b at the time of lifting up and supporting the care recipient 2 by obtaining the height information, joint position information and thickness information of the care recipient 2 as the body information, and can perform an operation comfortable to the care recipient 2 and let the care recipient 2 take a posture with little burden.

If standard joint position information and thickness information can be generated from the obtained height information and weight information, the height information and the weight information may be obtained as the body information. For example, a standard body table including standard joint position information and standard thickness information for standard heights and standard weights may be provided, and the standard joint position information and the standard thickness information may be obtained based on this standard body table.

Further, body part information such as the positions of injured or wounded parts of the care recipient 2 that cannot be moved may also be obtained. By obtaining this body part information beforehand, operations comfortable to the care recipient 2 and postures with little burden can be set as operational conditions beforehand for the basic transfer operations of the transfer supporting apparatus 1. This is described in detail later.

The controller 110 sets movement paths along which the supporting members 16a, 16b are moved. In other words, the controller 110 generates the movement posture/path information for determining the target positions and the target postures of the supporting members 16a, 16b based on the obtained body information when the care recipient 2 is to be held by the supporting members 16a, 16b. Further, the controller 110 controls the joint drivers 114, the position drivers 166, the elevation drivers 118 and the belt drivers 25 based on the movement posture/path information. In this way, the positions/postures of the supporting members 16a, 16b can be controlled to reach the target positions and the target postures.

The operating units 14a, 14b (input units) are for inputting instruction information for the operation of the transfer supporting apparatus 1. The operating units 14a, 14b obtains instruction information as an example of operative intention by means of six-axis force sensors for detecting operating forces acting in forward, backward, leftward, rightward, upward and downward directions and rotations in the respective directions. This instruction information is transmitted to the controller 110, which controls the respective drivers described above. The operating units 14a, 14b can be of any form provided that they can virtually generate external forces. For example, known input means such as a joystick, a lever, push switch or a touch panel can be used according to necessary instruction information. The caregiver 3 can maneuver the transfer supporting apparatus 1 by operating the operating units 14a, 14b. The operating units 14a, 14b may further include notification means or display means for assisting the input operation.

Next, an electrical construction of the transfer supporting apparatus 1 is described with reference to FIG. 3. As shown in FIG. 3, the transfer supporting apparatus 1 is provided with the operating units 14a, 14b for inputting operation instructions, the joint drivers 114 for driving the joints 13a, 13b, 15a and 15b, the belt drivers 25 for driving the belts 23a, 23b, the elevation drivers 118 for sliding the leg units 8a, 8b, the positions drivers 116 for driving the bases 6a, 6b and the controller 110. Further, the transfer supporting apparatus 1 is provided with the body information obtaining unit 600 for obtaining the body information of the care recipient 2 and a plurality of placement detection sensors 32a, 32b for detecting placed states of the supporting members 16a, 16b as input/output means. Driving means using known motors or the like as power sources can be used as the joint drivers 114, the belt drivers 25, the elevation drivers 118 and the position drivers 116.

Next, functions of the transfer supporting apparatus 1 are described.

First of all, by the above construction, the controller 110 obtains the body information indicating the physical features of the care recipient 2 from the body information obtaining unit 600 and generates the movement posture/path information for determining the target positions and the target postures of the plurality of supporting members 16a, 16b based on the obtained body information in the transfer supporting apparatus 1 according to this embodiment of the present invention. The controller 110 functions as an operation correcting unit for correcting the movements of the supporting members 16a, 16b based on the operation of the operating units 14a, 14b by driving the above respective drivers 114, 116, 118 (actuators) so that the supporting members 16a, 16b move in conformity with the generated movement posture/path information (movement paths). In other words, the controller 110 controls the joint drivers 114, the position drivers 116, the elevation drivers 118 and the belt drivers 25 based on the movement posture/path information. In this way, the transfer supporting apparatus 1 can be so controlled that the positions/postures of the supporting members 16a, 16b reach the target positions and the target postures.

Further, the transfer supporting apparatus 1 can detect the placement of the supporting members 16a, 16b on the placing surface by sliding movements of the leg units 8a, 8b using the placement detection sensors 32a, 32b arranged on the lower surfaces of the supporting members 16a, 16b while being spaced apart from each other.

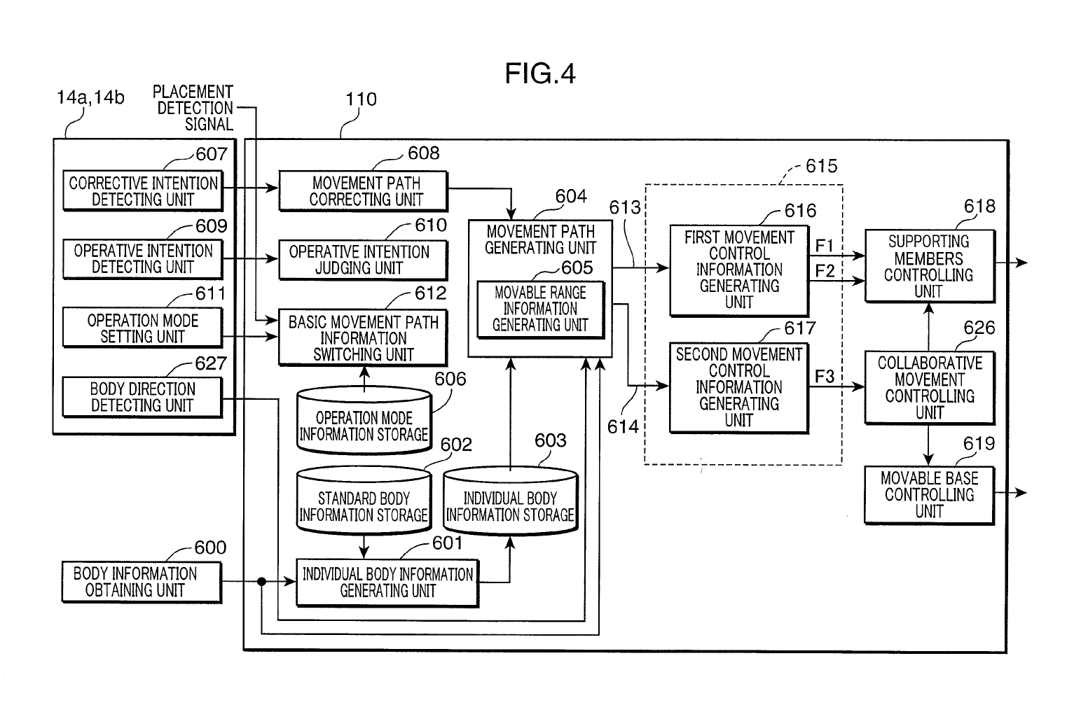

Next, a movement control based on the movement posture/path information of the transfer supporting apparatus 1 is described in detail. FIG. 4 is a block diagram showing a construction relating to the movement control of the transfer supporting apparatus 1 in this embodiment of the present invention.

As shown in FIG. 4, the operating units 14a, 14b each include an operative intention detecting unit 609 for detecting an operative intention of the caregiver 3, a corrective intention detecting unit 607 for detecting a correction intention when the caregiver 3 corrects the movement postures/paths, an operation mode setting unit 611 for setting a operation mode and a body direction detecting unit 627 for obtaining the orientation of the head of the care recipient 2, and various operation instructions are input in conformity with a movement of the transfer supporting apparatus 1.

The operative intention detecting unit 609 judges the presence of an operative intention of the caregiver 3 when the operating unit 14a, 14b are operated in specified directions with specified forces for a specified period by the caregiver 3. The operative intention detecting unit 609 outputs the operative intention information of moving/maintaining the transfer supporting apparatus 1 according to the operative intention of the caregiver 3. In the case of not moving the transfer supporting apparatus 1, the transfer supporting apparatus 1 maintains its state before the operation. The operative intention information is information relating to the intention of the caregiver 3, the start, stop, maintenance of the operation and the like can be reflected on a movement path generating section 604 via an operative intention judging unit 610.

In order to avoid a hypersensitive response to the operation of the operating units 14a, 14b, specified dead zones may be provided for operating directions and operating forces.

The corrective intention detecting unit 607 detects the presence of the corrective intention of the caregiver 3 when the operating units 14a, 14b are operated by the caregiver 3 in directions deviated from the determined movement paths for the target positions and the target postures set based on the movement posture/path information. Here, the corrective intention detecting unit 607 judges the presence of an input when the operating units 14a, 14b are operated with specified forces for a specified period. The corrective intention detecting unit 607 outputs the corrective intention information used to correct the target positions and the target postures set in the transfer supporting apparatus 1 according to the corrective intention of the caregiver 3. In the case of not correcting the target positions and the target postures of the transfer supporting apparatus 1, the movement posture/path information is not corrected.

In the operation mode setting unit 611, the operation mode corresponding to each movement is set upon transferring the care recipient 2. For example, the operation modes are set for the basic transfer operations such as a first operation mode for placing the supporting members 16a, 16b on the placing tool and inserting them between the care recipient 2 and the placing tool (insertion mode), a second operation mode for lifting up the care recipient 2 by moving the supporting members 16a, 16b upward (lift-up mode), a third operation mode for moving the care recipient 2 to a second placing tool (not shown) by moving the supporting members 16a, 16b (loading movement mode), a fourth operation mode for lowering the care recipient 2 to the placing surface of the second placing tool by lowering the supporting members 16a, 16b (lift-down mode) and a fifth operation mode for pulling out the supporting members 16a, 16b from between the care recipient 2 and the placing tool (pull-out mode). The caregiver 3 can operate the transfer supporting apparatus 1 for a series of basic transfer operations by selecting the respective operation modes according to these five divided transfer modes in the case of transferring the care recipient 2. It goes without saying that the transfer can be further segmented in consideration of preparations before and after the operation and other steps in addition to these basic transfer operations.

The controller 110 obtains the body information indicating the features relating to the body of the care recipient 2 from the body information obtaining unit 600. For example, the movement path generating unit 604 directly obtains the height information, the joint position information and the thickness information as the body information. A movable range information generating unit 605 generates movable range information indicating bending directions and movable ranges of the joints of the care recipient 2 based on the obtained height information, joint position information and thickness information. The movement path generating unit 604 generates information on restricted first movement postures/paths for the positions/postures of the supporting members 16a, 16b based on the generated movable range information.

The movement path generating unit 604 may indirectly obtain the height information, the joint position information and the thickness information. In this case, standard joint position information and standard thickness information are generated based on the height information and the weight information.

For example, a standard body table including standard joint position information and standard thickness information corresponding to standard heights and standard weights may be stored in a standard body information storage 602, and an individual body information generating unit 601 generates the standard joint position information and the standard thickness information from the height information and the weight information in accordance with this standard body table and individually stores the height information, the standard joint position information and the standard thickness information in an individual body information storage 603.

The movable range information generating unit 605 generates the movable range information indicating the bending directions and movable ranges of the joints of the care recipient 2 based on the height information, the standard joint position information and the standard thickness information stored in the individual body information storage 603. The movement path generating unit 604 generates the information on the restricted first movement postures/paths for the positions/postures based on the generated movable range information.

In this way, the height information and the weight information managed as general information can be utilized as the body information.

Further, the controller 110 may obtain the body part information such as the positions of injured or wounded body parts of the care recipient 2 that cannot be moved. In this case, the movable range information generating unit 605 generates the movable range information indicating the bending directions and movable ranges of the joints of the care recipient 2 based on the body part information and the movement path generating unit 604 generates the information on the restricted first movement postures/paths for the positions/postures of the supporting members 16a, 16b based on the movable range information generated by the movable range information generating unit 605.

By obtaining the body part information beforehand in this way, it is possible to set operations comfortable to the care recipient 2 and a posture with little burden as operational conditions beforehand for the basic transfer operations performed by the transfer supporting apparatus 1. In this way, when being lifted up from a bed or the like, the care recipient 2 can be lifted up by generating movable range information avoiding injured and/or wounded body parts from the body part information, generating the restricted first movement posture/path information for relative positions and relative postures based on the generated movable range information and setting the distance between the supporting members 16a, 16b so that the supporting members 16a, 16b move along the movement postures/paths based on the first movement posture/path information. Further, if the body part information indicating that the care recipient 2 has an injured lower back is present, the restricted first movement posture/path information can be generated by setting a restricted operational condition for the bending angle of the supporting members 16a, 16b. Thus, the transfer supporting apparatus 1 can be realized which can be safer and more secure to the care recipient 2.

Basic movement posture/path information for the basic operations is obtained from the operation mode information storage 606 according to the operation mode set by the operation mode setting unit 611, and information used to assist the basic operation relating to this operation mode is output to the movement path generating unit 604.

The operation mode setting unit 611 can determine the set operation mode as a starting operation mode and perform the above first to fifth operation modes while sequentially and automatically setting all or some of them. In this way, the transfer supporting apparatus 1 can sequentially and automatically perform all or some of the above first to fifth operation modes in the case of performing the transfer operations. The caregiver 3 may perform the necessary operation mode according to the transfer mode. Further, a specific operation mode may be selected and performed.

A basic movement path information switching unit 612 selects and obtains the basic movement posture/path information stored beforehand in the operation mode information storage 606 according to the operation mode to be performed, and sends it to the movement path generating unit 604. Accordingly, the caregiver 3 can receive assistance to the basic operations relating to the first to fifth operation modes only by selecting the necessary operation mode out of a plurality of operation modes.

The controller 110 outputs first movement posture/path information 613 and second movement posture/path information 614 relating to operations necessary for the transfer supporting apparatus 1 to transfer the care recipient 2 for each of the first to fifth operation modes from the movement path generating unit 604.

The controller 110 judges the operative intention information from the operative intention detecting unit 609 using the operative intention judging unit 610 and determines whether or not to operate the transfer supporting apparatus 1 according to the operative intention of the caregiver 3. In the case of not operating the transfer supporting apparatus 1, the transfer supporting apparatus 1 maintains a state before the operation. The controller 110 judges the corrective intention information from the corrective intention detecting unit 607 using the movement path correcting unit 608 and determines whether or not to correct the position/posture of the transfer supporting apparatus 1 and the positions/postures of the supporting members according to the corrective intention of the caregiver 3. In the case of further correcting the position/posture of the transfer supporting apparatus 1, contents of correction are notified to the movement path generating unit 604. In the case of making no correction, nothing is notified to the movement path generating unit 604, with the result that the movement posture/path information is not corrected.

A movement control information generating unit 615 includes a first movement control information generating unit 616 for generating movement control information used to control the positions/postures of the plurality of supporting members 16a, 16b based on the above first movement posture/path information 613 and a second movement control information generating unit 617 for generating movement control information used to control the position/posture of the entire device based on the second movement posture/path information 614.

The movement control information (F1, F2) generated in the first movement control information generating unit 616 is output to a supporting member controlling section 618 and the positions/postures of the supporting members 16a, 16b are controlled while the supporting members 16a, 16b are moved in a collaborative manner. The supporting member controlling unit 618 controls relative positions and postures of the care recipient 2 and the left and right supporting members 16a, 16b using the movement control information (F1, F2) based on the first movement posture/path information 613. In this way, the supporting member controlling unit 618 operates the leg units 8a, 8b to vertically move the supporting members 16a, 16b and, in addition, rotates the supporting members 16a, 16b about the X-axes and inclines them about the Y-axes if necessary using the rotating mechanisms provided in the joints 13, 13b, 15a and 15b.

The movement control information (F3) generated in the second movement control information generating unit 617 is sent to a collaborative movement controlling unit 626 for controlling the position/posture of the entire apparatus.

The collaborative movement controlling unit 626 sends a control signal to the supporting member controlling unit 618 to correct the positions/postures of the supporting members 16a, 16b based on the information on the position/posture of the entire apparatus and, further, sends a control signal for controlling the position of the entire apparatus to a movable base controlling unit 619. In this way, the collaborative movement controlling unit 626 controls to correct the position/posture of the entire device and, accordingly, the positions/postures of the supporting members 16a, 16b in accordance with the movement control information (F3) based on the second movement posture/path information 614.

The present positions and postures of the supporting members 16a, 16b are successively detected by detectors (not shown), fed back to the supporting member controlling unit 618 and the movable base controlling unit 619 and reflected on the movable range information generating unit 605 based on the body information, whereby the posture of the transfer supporting apparatus 1 is controlled to the one with little burden to the care recipient 2.

As described above, the transfer supporting apparatus 1 generates the first and second movement posture/path information for determining the target positions and target postures of the left and right supporting members 16a, 16b based on the body information in the movement path generating unit 604. The transfer supporting apparatus 1 also controls its operation based on the first and second movement posture/path information and the operative intention information.

Next, a process relating to the relative positions and relative postures of the care recipient 2 and the supporting members 16a, 16b is described.

The movement path generating unit 604 generates the first movement posture/path information 613 for determining first movement posture/path to maintain predetermined operational conditions concerning the relative positions and relative postures of the care recipient 2 and the supporting members 16a, 16b. The movement path generating unit 604 also generates the second movement posture/path information 614 for determining second movement path/posture to define the first movement posture/path. The first and second movement paths/postures are described in detail later.

The operational condition is such that supporting members 16a, 16b are respectively substantially parallel to the care recipient 2 at contact positions with the care recipient 2, and the supporting members 16a, 16b and the care recipient 2 are free from relative position displacements and relative posture displacements. Thus, the supporting members 16a, 16b are unlikely to cause the skin abrasion of the care recipient 2 during their operation.

The movement path generating unit 604 detects the orientation of the head of the care recipient 2 using the body direction detecting unit 627 and sets the first or second movement posture/path information 613 so as to prevent the feet of the care recipient 2 from being located higher than the head. In this way, it becomes difficult to set a posture imposing a burden on the care recipient 2.

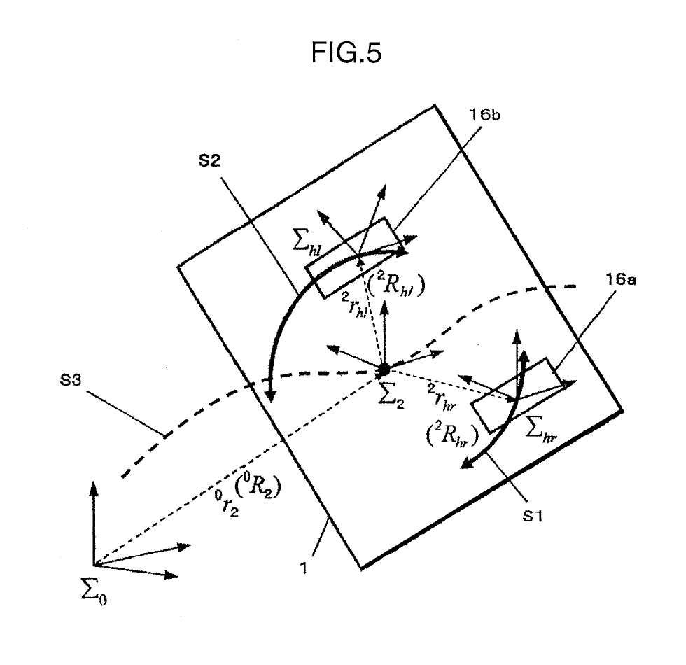

Next, a method for generating the first and second movement posture/path information 613, 614 as the movement control information for controlling the absolute positions and absolute postures of the supporting members 16a, 16b of the transfer supporting apparatus 1 and the entire transfer supporting apparatus 1 in the movement path generating unit 604 is described with reference to FIGS. 5 to 11.

FIG. 5 is a perspective view showing the definition of the first movement postures/paths of the transfer supporting apparatus 1. In FIG. 5, S1, S2 denote the first movement postures/paths as movement paths relating to the relative positions and relative postures of the care recipient 2 and the supporting members 16a, 16b. The first movement postures/paths S1, S2 are determined based on the first movement posture/path information 613. S3 denotes a second movement posture/path defining the first movement postures/paths. The second movement posture/path S3 is determined based on the second movement posture/path information 614 for controlling the absolute position and absolute posture of the entire transfer supporting apparatus 1. The transfer supporting apparatus 1 of this embodiment calculates virtual external forces to be exerted to the supporting members 16a, 16b and the transfer supporting apparatus 1 using virtual potential energies concerning the motion of the transfer supporting apparatus 1 and determines the movement postures/paths and movable ranges.

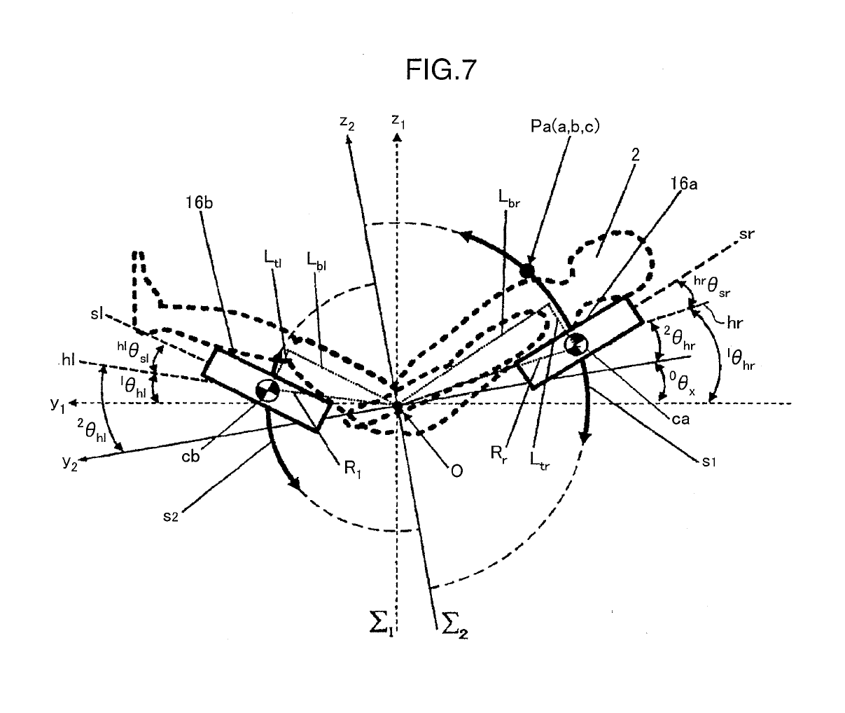

Here, symbols shown in FIGS. 5 and 7 are described.

Σ₀ denotes a reference coordinate system which is coordinate system at rest.

Σ₂ denotes a coordinate system of the entire supporting members 16a, 16b which moves together with the supporting members 16a, 16b with a point representing the entire supporting members 16a, 16b as an origin.

Σ₁ denotes a coordinate system whose origin coincides with the representative point of the supporting members 16a, 16b and whose X-axis coincides with the X-axis of Σ₂. Σ₁ is the coordinate system serving as the basis of Σ₂.

Σₕᵣ denotes a coordinate system of the supporting member 16a which is fixed to the supporting member 16a and moves together with the supporting member 16a.

Σₕₗ denotes a coordinate system of the supporting member 16b which is fixed to the supporting member 16b and moves together with the supporting member 16b.

⁰r₂ denotes a position vector from Σ₀ to Σ₂.

²rₕᵣ denotes a position vector from Σ₂ to Σₕᵣ.

²rₕₗ denotes a position vector from Σ₂ to Σₕₗ.

⁰R₂ denotes a rotation matrix expressing the posture of Σ₂ when viewed from Σ₀.

²Rₕᵣ denotes a rotation matrix expressing the posture of Σₕᵣ when viewed from Σ₂.

²Rₕₗ denotes a rotation matrix expressing the posture of Σₕₗ when viewed from Σ₂.

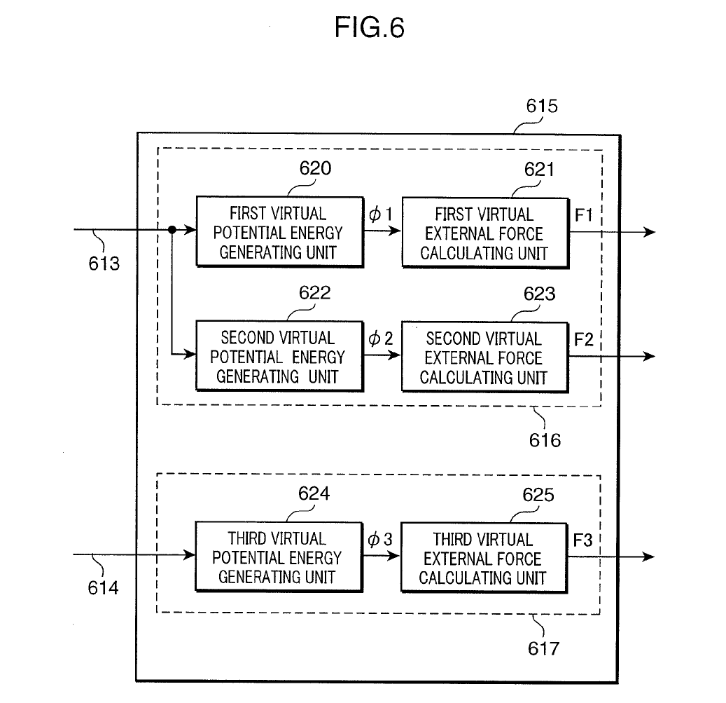

As shown in FIG. 6, a first virtual potential energy generating unit 620 and a second virtual potential energy generating unit 622 have the first movement posture/path information 613 input thereto and generate virtual potential energy at each point on the first movement postures/paths based on the first movement posture/path information 613. A first virtual external force calculating unit 621 and a second virtual external force calculating unit 623 respectively output virtual external force information F1, F2 based on the virtual potential energies to the supporting member controlling unit 618.

Similarly, a third virtual potential energy generating unit 624 has the second movement posture/path information 614 input thereto and generates virtual potential energy at each point on the second movement posture/path based on the second movement posture/path information 614. A third virtual external force calculating unit 625 sends virtual external force information F3 based on the virtual potential energy to the collaborative movement controlling unit 626. The collaborative movement controlling unit 626 outputs the virtual external force information relating to the entire transfer supporting apparatus 1 to the movable base controlling unit 619 and outputs the virtual external force information relating to the supporting members 16a, 16b to the supporting member controlling unit 618.

FIG. 7 shows a relative positional relationship of the care recipient 2 and the supporting members 16a, 16b. Here, the coordinate system Σ₂ is rotated by ⁰θx about the X-axis with respect to the coordinate system Σ₁. A condition for locating the head higher than the feet is defined as shown in the following equation (2) concerning the movement restriction of the supporting members 16a, 16b based on the body information.

Symbols in FIG. 7 are described below.

O denotes a joint position (hip joint position) of the care recipient 2.

sr denotes a straight line passing through a center ca of the supporting member 16a and parallel to a plane on which the supporting member 16a supports the care recipient 2.

hr denotes a straight line connecting the joint position O of the care recipient 2 and the center ca of the supporting member 16a.

sl denotes a straight line passing through a center cb of the supporting member 16b and parallel to a plane on which the supporting member 16b supports the care recipient 2.

hl denotes a straight line connecting the joint position O of the care recipient 2 and the center cb of the supporting member 16b.

¹θₕₗ denotes an angle between a y-axis (y1) of Σ₁ and an hl-axis about an x-axis of Σ₁. ¹θₕₗ is positive in a clockwise direction of FIG. 7.

²θₕₗ denotes an angle between a y-axis (y2) of Σ₂ and an hl-axis about the x-axis of Σ₁. ²θₕₗ is positive in the clockwise direction of FIG. 7.

^{hl}θₛₗ denotes an angle between the hl-axis and an sl-axis about the x-axis of Σ₁. ^{hl}θₛₗ is positive in the clockwise direction of FIG. 7.

¹θₕᵣ denotes an angle between the y-axis (y1) of Σ₁ and an hr-axis about the x-axis of Σ₁. ¹θₕᵣ is positive in a counterclockwise direction of FIG. 7.

²θₕᵣ denotes an angle between the y-axis (y2) of Σ₂ and an hr-axis about the x-axis of Σ₁. ²θₕᵣ is positive in the counterclockwise direction of FIG. 7.

^{hr}θₛᵣ denotes an angle between the hr-axis and an sr-axis about the x-axis of Σ₁. ^{hr}θₛᵣ is positive in the counterclockwise direction of FIG. 7.

⁰θx denotes an angle between the y-axis (y1) of Σ₁ and the y-axis (y2) of Σ₂ about the x-axis of Σ₁. ⁰θx is positive in the counterclockwise direction of FIG. 7, but may be positive in the clockwise direction.

¹θ+θ≦¹θ+θ (2)

A condition for setting the bending angle of the care recipient 2, for example, to 0 to 90° is defined as in the following equation (3).

0°≦(²θ+^{hl}θ)+(²θ+^{hr}θ)≦90° (3)

If it is assumed that Rᵣ, R₁ denote distances from the joint position O (hip joint position) of the care recipient 2 to the centers ca, cb of the supporting members 16a, 16b, L_{br} L_{bl} denote lengths based on the height information and Lₜᵣ, Lₜ₁ denote thicknesses based on the thickness information indicating the thickness of the care recipient 2 (e.g. a value which is half the thickness from the back to the chest), conditions defined by the following equations (4), (5) are set.

Rᵣ=\sqrt{L_{br}²+Lₜᵣ²} (4)

Rₗ=\sqrt{L_{bl}²+Lₜₗ²} (5)

Here, it is assumed that a positive direction of the right supporting member is the counterclockwise direction and that of the left supporting member is the clockwise direction. The supporting members 16a, 16b are respectively located on the first movement postures/paths S1, S2 and are kept in such postures substantially parallel to the care recipient 2 at the contact positions with the care recipient 2.

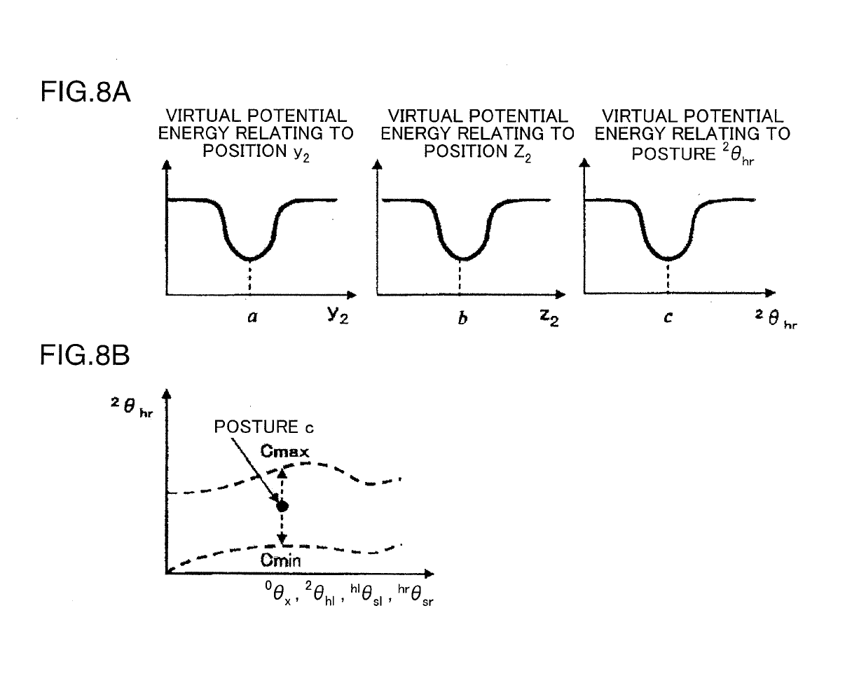

FIGS. 8 show examples of the virtual potential energy at point Pa (position/posture) on the first movement posture/path when viewed from the coordinate system Σ₂. If Pa(a, b, c) denotes the position/posture at the point Pa (see FIG. 7) on the first movement posture/path (S1), states of the virtual potential energy relating to a position y2, the virtual potential energy relating to a position z2 and the virtual potential energy relating to a posture ²θₕᵣ are shown in FIG. 8A.

FIG. 8B shows posture restriction based on the height information concerning the posture of the supporting members 16a at the respective points on the first movement posture/path (S1). Here is shown an example of a possible range of ²θₕᵣ defining the posture of the supporting member 16a when ⁰θₓ, ²θₕₗ, ^{hr}θₛᵣ, ^{hl}θₛₗ take certain values.

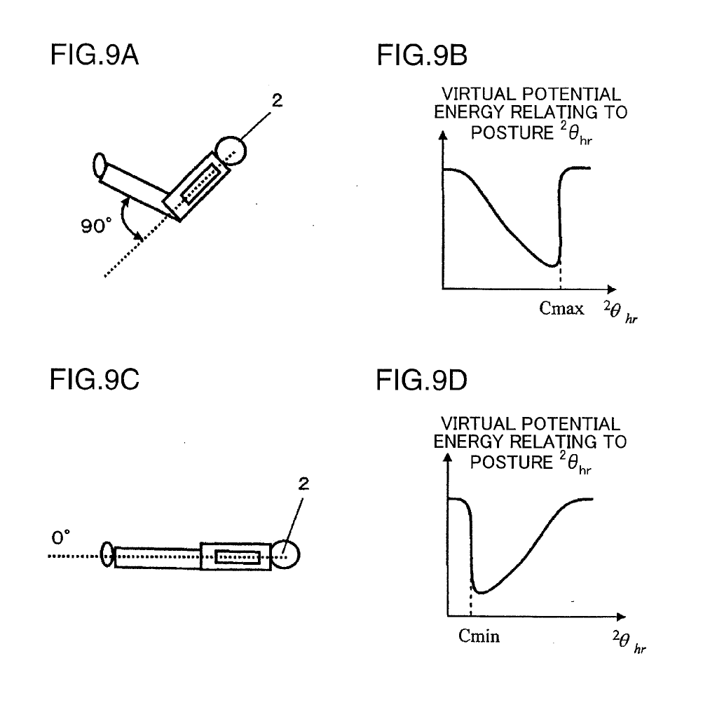

As shown in FIGS. 9A and 9B, a restriction condition for a posture c differs depending on the bending angle when the care recipient 2 is held by the supporting members 16a, 16b. For example, if the care recipient 2 is lifted up in a posture of 90° by the supporting members 16a, 16b as shown in FIG. 9A, the virtual potential energy relating to the posture ²θₕᵣ is as shown in FIG. 9B. If the bending angle of the care recipient 2 exceeds 90°, a burden is imposed on the care recipient 2. Thus, the virtual potential energy suddenly increases at or above Cmax so that the posture c does not reach Cmax or higher as shown in FIG. 9B. The transfer supporting apparatus 1 is so controlled as to set the bending angle below 90° since being controlled to move the supporting members 16a, 16b toward sides where the virtual potential energies decrease. Therefore, the transfer supporting apparatus 1 can be provided which is safe and secure and does not impose a burden on the care recipient 2.

Similarly, FIG. 9C shows an example of the virtual potential energy relating to the posture ²θₕᵣ when the care recipient 2 is lifted up in a posture of 0° by the supporting members 16a, 16b. Since the body of the care recipient 2 is warped in the posture c with an angle equal to or below Cmin, the virtual potential energy is generated to suddenly increase at or below Cmin so that the body of the care recipient 2 is in such a posture c as not to be warped.

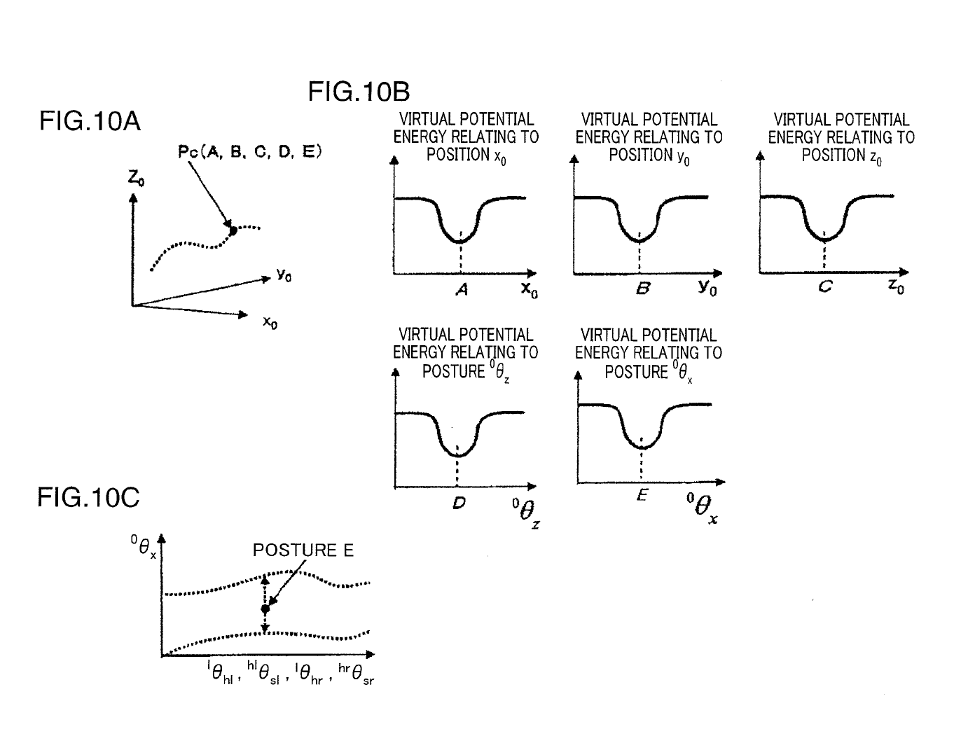

Next, the virtual potential energies at positions on the second movement posture/path are described with reference to FIG. 10.

If Pc(A, B, C, D, E) denotes absolute position and absolute posture at a point Pc on the second movement posture/path in FIG. 10A, FIG. 10B shows virtual potential energies at the respective positions A, B, C and in postures D, E. Here, the posture D is a posture in a moving direction of the transfer supporting apparatus 1 and the posture E is an inclined posture of the transfer supporting apparatus 1. FIG. 10C relates to the posture E at the respective positions on the second movement posture/path and shows a range satisfying the operational conditions predetermined for the positions/postures of the supporting members 16a, 16b based on the first movement postures/paths according to the body information. The transfer supporting apparatus 1 generates suitable virtual potential energy in conformity with the determined posture E and controls the inclined posture of the transfer supporting apparatus 1 toward a side where this virtual potential energy decreases.

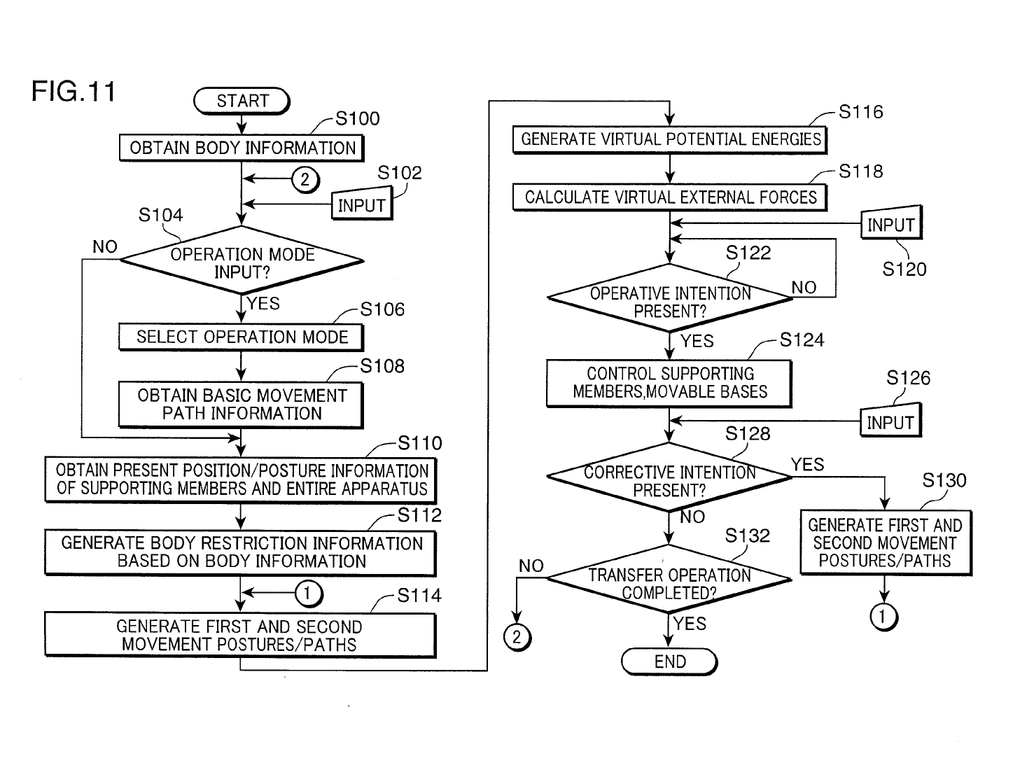

Next, the operation of the transfer supporting apparatus 1 is described. FIG. 11 is a flow chart showing the operation of the transfer supporting apparatus 1 in this embodiment.

As shown in FIG. 11, the transfer supporting apparatus 1 obtains the body information of the care recipient 2 using the body information obtaining unit 600 when the entire apparatus approaches a placing tool (S100).

Subsequently, the transfer supporting apparatus 1 sets the operation mode for setting the basic operation according to the transfer mode (Step S102). If a new operation mode is set, the basic movement path information corresponding to the set operation mode is selected and obtained from the operation mode information storage 606 using the basic movement path information switching unit 612 and sent to the movement path generating unit 604. If the set operation mode is same, Steps S106 and S108 are skipped (S104, S106, S108).

Subsequently, the transfer supporting apparatus 1 obtains information on the present positions/postures of the supporting members 16a, 16b and information on the present position/posture of the entire transfer supporting apparatus 1 (S110), and generates movement restriction information (hereinafter, the movement restriction information indicating movable ranges is referred to as “movable range information”) according to the present positions/postures of the supporting members 16a, 16b and the present position/posture of the entire transfer supporting apparatus 1 based on the body information using the movable range information generating unit 605 (S112).

Subsequently, the transfer supporting apparatus 1 outputs the first movement posture/path information 613 as information on the first movement postures/paths for determining the positions/postures of the supporting members 16a, 16b and outputs the second movement posture/path information 614 as information on the second movement posture/path for determining the present position/posture of the entire transfer supporting apparatus 1 based on the movable range information for each operation mode using the movement path generating unit 604 (S114).

Subsequently, the transfer supporting apparatus 1 generates virtual potential energies based on the first movement posture/path information 613 using the first and second virtual potential energy generating units 620, 622. The first and second virtual external force calculating units 621, 623 send the virtual external force information F1, F2 to the supporting member controlling unit 618 to move the supporting members 16a, 16b toward the sides where the virtual potential energies decrease based on the virtual potential energies. In this way, the transfer supporting apparatus 1 controls the positions/postures of the supporting members 16a, 16b so that the supporting members 16a, 16b move along the first movement postures/paths suitable for the basic operation based on the body information. Thus, the caregiver 3 can operate the transfer supporting apparatus 1 without being aware of the relationship of the care recipient 3 and the supporting members 16a, 16b point by point. Similarly, the transfer supporting apparatus 1 generates the virtual potential energy in the third virtual potential energy generating unit 624 to control the posture of the transfer supporting apparatus 1 on the second movement posture/path based on the second movement posture/path information 614, and sends the virtual external force information F3 to the collaborative movement controlling unit 626 to change the posture of the transfer supporting apparatus 1 toward the side where this virtual potential energy decreases in the third virtual external force calculating unit 625. The collaborative movement controlling unit 626 sends the virtual external force information relating to the entire transfer supporting apparatus 1 to the movable base controlling unit 619 and sends the virtual external force information relating to the positions/postures of the supporting members 16a, 16b to the supporting member controlling unit 618 (S116, S118).

Subsequently, the transfer supporting apparatus 1 judges the presence or absence of an operative intention based on the information from the operative intention detecting unit 609 as to whether or not the caregiver 3 is continuing to make an operation input to the operating units 14a, 14b with specified operation forces for a specified period, using the operative intention judging unit 610 (S120, S122). In the case of not operating the transfer supporting apparatus 1, the transfer supporting apparatus 1 maintains its position and posture before the operation input. In the case of operating the transfer supporting apparatus 1, the positions/postures of the supporting members 16a, 16b and the position/posture of the entire transfer supporting apparatus 1 are controlled (S124).

Subsequently, the transfer supporting apparatus 1 judges the presence or absence of a corrective intention in the corrective intention detecting unit 607 from information as to whether the caregiver 3 is continuing to make a corrective intention input to the operating units 14a, 14b with specified forces for a specified period, using the movement path correcting unit 608 (S126, S128). If the caregiver 3 intends to correct the positions/postures of the supporting members 16a, 16b and the position/posture of the entire transfer supporting apparatus 1, contents of correction are notified to the movement path generating unit 604 (S130). The movement path generating unit 604 corrects the first and second movement postures/paths based on the basic movement posture/path information according to the contents of correction and, then, this routine returns to S114 to generate the first and second movement postures/paths. The movement path correcting unit 608 sends nothing to the movement path generating unit 604 in the case of not correcting the movement posture/path information.

Subsequently, it is judged whether or not the transfer operation has been completed (S132). If the fifth operation mode has been completed and the target positions and the target postures have been reached in the fifth operation mode, this process is ended. On the other hand, unless the process has been completed, this routine returns to Step S104.

Steps S104 to S132 are repeated hereinafter until the process is completed.

The present positions/postures of the supporting members 16a, 16b are successively detected, suitable virtual potential energies on the first and second movement postures/paths are generated every time and a control is executed to move the supporting members 16a, 16b and the transfer supporting apparatus 1 toward the sides where the virtual potential energies decrease. In this way, the transfer supporting apparatus 1 can control the positions/postures of the supporting members 16a, 16b and the position/posture of the transfer supporting apparatus 1 so as to have a posture with little burden on the care recipient 2 at any point on the first and second movement postures/paths based on the body information of the recipient 2.

The operation modes may be automatically switched using the placement detection sensors 32a, 32b. An exemplary case where the care recipient 2 is lifted up by the supporting members 16a, 16b, moved and transferred to another bed or the like is described. In this case, the caregiver 3 normally inputs the fourth operation mode using the operating units 14a, 14b to lower the supporting members 16a, 16b, thereby lowering the care recipient 2 to a bed surface. The caregiver 3 completes the fourth operation mode upon confirming the placement of the supporting members 16a, 16b on the bed surface. Subsequently, the fifth operation mode is input using the operating units 14a, 14b to pull out the supporting members 16a, 16b from between the care recipient 2 and the bed. Thus, in a mode for automatically and sequentially proceeding from the fourth operation mode to the fifth operation mode (e.g. automatic mode), the transfer supporting apparatus 1 automatically switches the operation mode to the fifth operation mode to pull out the supporting members 16a, 16b from between the care recipient 2 and the bed when the supporting members 16a, 16b are lowered to lower the care recipient 2 to the bed surface and the placement of the supporting members 16a, 16b on the bed surface is detected by the placement detection sensors 32a, 32b in the fourth operation mode. In this way, burdens on the caregiver 3 can be reduced and smooth operation is enabled.

According to the transfer supporting apparatus 1 of the above embodiment, the operation of the operator can be assisted based on the body information indicating the features relating to the body of the care recipient 2. Thus, even in the case of operation by the caregiver 3 with a low skill, the transfer supporting apparatus 1 can be provided which enables an operation comfortable to the care recipient 2 and a posture with little burden on the care recipient 2.

Although the transfer supporting apparatus 1 according to this embodiment transfers the care recipient 2 needed to be cared, it is sufficient to transfer a human body. For example, the present invention is similarly applicable to the transfer of an operator himself or a person to whom it is difficult to move his own body, and a human body can be lifted up from a placing tool and transferred.

Although the transfer supporting apparatus 1 according to this embodiment is described for the case of controlling the position/posture of the transfer supporting apparatus 1 based on the body information, the position/posture of the transfer supporting apparatus 1 may be controlled utilizing environment information around the transfer supporting apparatus 1. In this way, there can be realized the transfer supporting apparatus 1 for controlling position/posture which can avoid contact with the surrounding.

Specifically, in this other embodiment, a transfer supporting apparatus is provided with a plurality of supporting members for lifting up a human body lying on a placing tool, a body information obtaining unit for obtaining body information indicating features of the human body, a movement path generating unit for generating movement posture/path information for determining target positions and target postures of the plurality of supporting members based on the body information when the human body is to be held by the plurality of supporting members, and a supporting portion for supporting the plurality of supporting members to reach the target positions and the target postures based on the movement posture/path information.

According to such a construction, even in the case of operation by an operator with a low skill, it is possible to make movements comfortable to the human body and take a posture with little burden on the human body similar to the case of operation by an operator with a high skill since movements are made based on the body information indicating the features of the human body.

In this other embodiment, the movement path generating unit generates the first movement posture/path information to maintain a specified operational condition concerning relative positions and relative postures of the human body and the plurality of supporting members. According to this, it becomes further possible to maintain the relative positions and postures of the human body and the plurality of supporting members according to the operational condition and enable an operation while requiring even less skill to the caregiver.

In this other embodiment, a condition that the supporting members are substantially parallel to the human body at contact positions with the human body and the supporting members and the human body are free from relative position displacements and relative posture displacements is particularly set as the specified operational condition. According to this, since movements are made to cause no relative position displacement or no relative posture displacement of the supporting members and the human body, burdens on the body held by the supporting members can be further reduced for a care recipient.

In this other embodiment, height information, joint position information and thickness information are obtained as the body information, the movement path generating unit generates movable range information indicating bending directions and movable ranges of the respective joints of the human body based on the obtained height information, joint position information and thickness information and generates restricted first movement posture/path information for the relative positions and the relative postures based on the generated movable range information. According to this, burdens in the posture of the care recipient held by the supporting members can be further reduced.

In this other embodiment, height information and weight information are obtained as the body information, the movement path generating unit sets standard joint position information and thickness information based on the obtained height information and weight information, generates movable range information indicating bending directions and movable ranges of the respective joints of the human body based on the set height information, standard joint position information and thickness information and generates restricted first movement posture/path information for the relative positions and the relative postures based on the generated movable range information. According to this, even if the obtained body information is the height information and the weight information, the movable range information indicating the bending directions and movable ranges of the respective joints of the human body can be generated and burdens in the posture of the human body held by the supporting members can be reduced.

In this other embodiment, the standard joint position information and thickness information are set in accordance with a standard body table recorded with standard joint position information and standard thickness information corresponding to standard heights and standard weights. According to this, the movable range information indicating the bending directions and movable ranges of the respective joints of the human body can be generated in accordance with the standard body table and burdens in the posture of the human body held by the supporting members can be reduced.

In this other embodiment, body part information on body parts of the human body whose movements are restricted is further obtained as the body information, and the movement path generating unit generates restricted first movement posture/path information for the relative positions and the relative postures based on the body part information. According to this, the movable range information indicating the bending directions and movable ranges of the respective joints of the human body can be generated based on the body part information on the body parts of the human body whose movements are restricted, and burdens in the posture of the human body held by the supporting members can be reduced. For example, this is effective in the case where the human body is injured or wounded.

In this other embodiment, the movement posture/path information includes second movement posture/path for defining absolute positions and absolute postures of the plurality of supporting members, the movement path generating unit generates the movement posture/path information so that target positions and target postures of the plurality of supporting members corresponding to the first movement posture/path information are maintained at each point on the second movement posture/path.

According to this, an operator can efficiently perform the operation without being aware of the positions/postures of the supporting members considering the body features.

In this other embodiment, the movement path generating unit further includes a body direction detecting unit for obtaining body orientation information on the orientation of the human body, and the first or second movement posture/path information is so set based on the body orientation information as to locate the head of the human body higher than the feet.

According to this, it can be constantly prevented that the feet of the human body become higher than the head. Thus, the caregiver can prevent an unnatural movement, which will burden the care recipient, without being aware of it.

In this other embodiment, there are further provided an operative intention detecting unit for detecting operative intention information of the operator and a controller for controlling the supporting portion based on the operative intention information, the controller controls the supporting portion based on the movement posture/path information so that the plurality of supporting members reach target positions and target postures when the operative intention information is detected, while controlling the supporting portion to maintain the positions and postures of the plurality of supporting members as they are when no operative intention information is detected.

According to this, in the absence of the operative intention of the operator, movements can be so controlled as to maintain the position and posture of the apparatus, whereby a safe apparatus can be realized.

In this other embodiment, there are further provided a corrective intention detecting unit for detecting corrective intention information to be used by the operator to correct the movement posture/path information and a movement posture/path correcting unit for correcting the movement postures/paths based on the movement posture/path information according to the corrective intention information.

According to such a construction, the movement postures/paths can be corrected if they are different from those supposed beforehand.

In this other embodiment, a plurality of different operation modes are provided, and the movement path generating unit generates different pieces of movement posture/path information for the respective operation modes.

According to this, it is possible to set optimal basic movement posture/path information for each of the plurality of operation modes. Thus, operations supposed beforehand can be easily realized.

In this other embodiment, the plurality of operation modes include a first operation mode for inserting the plurality of supporting members between the human body and the placing tool, a second operation mode for lifting up the human body by moving the plurality of supporting members upward, a third operation mode for moving the human body to a second placing tool by moving the plurality of supporting members, a fourth operation mode for lowering the human body to a placing surface of the second placing tool by lowering the plurality of supporting members and a fifth operation mode for pulling out the plurality of supporting members from between the human body and the placing tool.

According to such a construction, a series of transfer operations can be smoothly performed.

In this other embodiment, the supporting portion generates virtual potential energies which increase with distance from the movement postures/paths with the movement postures/paths based on the movement posture/path information as centers and controls the plurality of supporting members to move the plurality of supporting members toward sides where the virtual potential energies decrease. According to this, movements of the plurality of supporting members to the target positions and the target postures can be easily assisted so as to be comfortable to the human body.

In this other embodiment, the virtual potential energies are generated based on the body information. According to this, even in the case of an erroneous operation by the operator, safety can be improved since the plurality of supporting members are so controlled as to be comfortable to the human body based on the body information.

### SUMMARY OF THE EMBODIMENTS

The summary of the above embodiments are described below.

(1) As described above, in this transfer supporting apparatus, the controller sets the movement paths along which the supporting member is moved, and corrects the movement of the supporting member based on the operation of the operating units by driving the actuators so that the supporting member moves along the movement paths. Thus, even in the case of the operation by an operator with a low skill in the operation of the transfer supporting apparatus, the operation of the operator is corrected by the controller. This enables the suppression of such an operation as to impose a burden on a person receiving the transfer support such as a posture improper to the body of this person. Therefore, the operator can easily operate the transfer supporting apparatus and the person receiving the transfer support can receive care at ease.

(2) The controller includes a physique information storage storing physique information of the person, and the movement path setting unit sets the movement path of the supporting member according to the physique of the person based on the physique information stored in the physique information storage. Thus, the supporting member can more easily reach a target position and a target posture according to the physique of the person.

(3) The controller includes a body information storage, body information stored in the body information storage includes information on an abnormal body part, and the movement path setting unit sets the movement path of the supporting member based on the information on the abnormal body part stored in the body information storage. Thus, this is effective, for example, in the case where a human body is injured or wounded.

(4) The transfer supporting apparatus of the above embodiments includes a first detector for detecting a distance between the transfer supporting apparatus and a placing tool and a second detector for detecting the height of the supporting member with respect to a placing surface of the placing tool, and the movement path setting unit sets the movement path of the supporting member so that the height of the supporting member detected by the second detector approaches the height of the placing surface as the distance between the transfer supporting apparatus and the placing tool detected by the first detector becomes shorter. Thus, it can be prevented that the supporting member is suddenly lowered immediately before the care recipient and anxiety and insecurity the care recipient could feel can be reduced.

(5) The transfer supporting apparatus of the above embodiments includes a pressure sensor arranged in the supporting member and capable of detecting a contact pressure between the placing surface of the placing tool, on which the person is supported, and the supporting member, and the operation correcting unit corrects the movement of the supporting member based on the operation of the operating units so that the contact pressure detected by the pressure sensor does not exceed a contact pressure predetermined in the controller. Thus, upon inserting the supporting member between the placing tool and the care recipient, it can be prevented that the supporting member excessively presses the placing tool.

(6) In the transfer supporting apparatus of the above embodiments, the supporting member include a first supporting member and a second supporting member, and the upper body of the person is supported by one of the first and second supporting members and the lower body of the person is supported by the other supporting members.

(7) In the transfer supporting apparatus of the above embodiments, the supporting members include a first supporting member and a second supporting member, the upper body of the person is supported by one of the first and second supporting members and the lower body of the person is supported by the other supporting members, the physique information stored in the physique information storage includes height information, and the controller sets a distance between the first and second supporting members based on the height information stored in the physique information storage. Thus, the distance between the first and second supporting members can be easily set to the one suitable for the height of the person.

(8) The transfer supporting apparatus of the above embodiments includes a hip position detector for detecting the position of the hip of the person, and the movement path setting unit sets movement paths of the first and second supporting members so that one of the first and second supporting members supports the upper body above the position of the hip and the other supporting member supports the lower body below the position of the hip.

(9) The controller includes a hip joint specifying unit for specifying the position of the hip joint of the person supported by the supporting member, and the movement path of the supporting member is set based on the position of the hip joint of the person specified by the hip joint specifying unit in an operation of bending the person supported by the supporting member.

(10) The movement path setting unit sets the movement paths of the first and second supporting members so that the first and second supporting members move while maintaining specified distances from the position of the hip joint with the person and the supporting member supporting the person held in contact. Thus, upon bending the person, it can be made difficult to displace the supporting member and the back of the person from each other.

(11) The controller includes a permissible bending angle setting unit for setting a permissible bending angle of the hip joint of the person in an operation of lifting up the person by the first and second supporting members and a bending angle calculating unit for calculating a bending angle of the hip joint of the person to be lifted up by the first and second supporting members, and the movements of the supporting members based on the operation of the operating units are corrected so that the bending angle calculated by the bending angle calculating unit lies in the range of the permissible bending angle set by the permissible bending angle setting unit in the operation of lifting up the person by the first and second supporting members. Thus, a posture uncomfortable to the person such as a warped state of the back and a pressed state of the abdomen can be prevented.

(12) The controller links movements of the first and second supporting members in a height direction and an operation of bending the hip joint of the person by the first and second supporting members in the operation of lifting up the person by the first and second supporting members. Thus, the hip joint of the person can be bent according to the height to which the person is lifted up by the first and second supporting members. Therefore, the person can be lifted up in such a posture comfortable to him.

(13) The controller includes a virtual potential energy setting unit for setting virtual potential energy specified by the magnitude of a force to be exerted to the supporting member according to a distance from the movement path set by the movement path setting unit to the supporting member, and the operation correcting unit corrects the movement of the supporting member based on the operation of the operating units by causing the force to be exerted to the supporting member so that the supporting member approaches the movement path based on the virtual potential energy set by the virtual potential energy setting unit. Thus, a posture uncomfortable to the person can be prevented by the action of the virtual potential energies.

(14) The transfer supporting apparatus of the above embodiments includes a first detector for detecting a distance between the transfer supporting apparatus and the placing tool, and the virtual potential energy setting unit sets the virtual potential energy so that the force exerted to the supporting member increases as the distance detected by the first detector decreases. Thus, a degree of freedom is ensured for the movement of the supporting member to make the supporting member easily usable by the operator in a place where the transfer supporting apparatus is distant from the placing tool, whereas the supporting member can reliably reach a target position or target posture by increasing the force exerted to the supporting member as the transfer supporting apparatus approaches the placing tool.

(15) The controller includes a physique information storage for storing physique information of the person, and the virtual potential energy setting unit sets virtual potential energy according to the physique of the person based on the physique information stored in the physique information storage. Thus, the supporting member can reach a target position and a target posture corresponding to the physique.

(16) The controller maintains the position and posture of the supporting member if no input is made by the operating units for the operation of the supporting member. Thus, unpredicted movements of the supporting member can be prevented when the operator inadvertently releases his hands from the operating units.

(17) The controller includes a correction canceling unit for canceling the function of the operation correcting unit. Thus, the restraint of the supporting member by the virtual potential energy can be temporarily canceled and the operator can freely operate the supporting member in such a case.

(18) The controller includes a movement path correcting unit for correcting the movement path set by the movement path setting unit, and the operation correcting unit corrects the movement of the supporting member based on the operation of the operating units by driving the actuators so that the supporting member moves along the movement path corrected by the movement path correcting unit when the movement path is corrected by the movement path correcting unit. Thus, if it is desired to appropriately correct the movement path automatically set in the transfer supporting apparatus, such a correction is permitted. Therefore, an operation in conformity with the operator's intention is possible.

(19) The transfer supporting apparatus of the above embodiments includes a posture information storage for storing information on the posture of the person supported by the supporting member, and the movement path setting unit sets the movement path based on the information on the posture of the person stored in the posture information storage so that the head of the person supported by the supporting members is located higher than the feet. Thus, an unnatural posture to impose a burden on the person can be prevented even without the operator being aware of it.

### INDUSTRIAL APPLICABILITY

As described above, the transfer supporting apparatus of the present invention is operated based on the body information/physique information indicating features relating to a human body. Thus, it is possible to perform an operation comfortable to the human body and let the human body take a posture with little burden even in the case of operation by an operator with a low skill similar to the case of operation by an operator with a high skill. Therefore, the present invention is useful as a transfer supporting apparatus with easily operation and high safety, a nursing aid robot and the like.

1. A transfer supporting apparatus, comprising:
a supporting member for supporting a person,
an operating unit for operating the supporting member, the supporting member being moved based on an operation of the operating unit,
an actuator for moving the supporting member, and
a controller for controlling the actuator based on an operation of the operating unit,
wherein the controller includes:
a movement path setting unit for setting a movement path of the supporting member, and
an operation correcting unit for correcting the movement of the supporting member based on the operation of the operating unit by driving the actuator so that the supporting member moves along the movement path set by the movement path setting unit.

2. A transfer supporting apparatus according to claim 1, wherein:
the controller includes a physique information storage for storing physique information of the person, and
the movement path setting unit sets the movement path of the supporting member according to the physique information of the person based on the physique information stored in the physique information storage.

3. A transfer supporting apparatus according to claim 1, wherein:
the controller includes a body information storage,
a body information stored in the body information storage includes information on an abnormal body part, and
the movement path setting unit sets the movement path of the supporting member based on the information on the abnormal body part stored in the body information storage.

4. A transfer supporting apparatus according to claim 1, further comprising:
a first detector for detecting a distance between the transfer supporting apparatus and a placing tool, and
a second detector for detecting a height of the supporting member with respect to a placing surface of the placing tool,
wherein the movement path setting unit sets the movement path of the supporting members so that the height of the supporting member detected by the second detector approaches a height of the placing surface as the distance between the transfer supporting apparatus and the placing tool detected by the first detector becomes shorter.

5. A transfer supporting apparatus according to claim 1, further comprising a pressure sensor arranged in the supporting member and capable of detecting a contact pressure between the placing surface of the placing tool supporting the person and the supporting member, wherein:
the operation correcting unit corrects the movement of the supporting member based on the operation of the operating unit so that the contact pressure detected by the pressure sensor does not exceed a contact pressure predetermined in the controller.

6. A transfer supporting apparatus according to claim 1, wherein:
the supporting member includes a first supporting member and a second supporting member, and
an upper body of the person is supported by one of the first and second supporting members and a lower body of the person is supported by the other supporting member.

7. A transfer supporting apparatus according to claim 2, wherein:
the supporting member includes a first supporting member and a second supporting member,
an upper body of the person is supported by one of the first and second supporting members and a lower body of the person is supported by the other supporting member,
the physique information stored in the physique information storage includes height information, and
the controller sets a distance between the first and second supporting members based on the height information stored in the physique information storage.

8. A transfer supporting apparatus according to claim 6, further comprising a hip detector for detecting a position of the hip of the person, wherein:
the movement path setting unit sets movement paths of the first and second supporting members so that one of the first and second supporting members supports the upper body of the person above the position of the hip and the other supporting member supports the lower body of the person below the position of the hip.

9. A transfer supporting apparatus according to claim 6, wherein:
the controller includes a hip joint specifying unit for specifying a position of the hip joint of the person supported by the supporting members, and
the movement paths of the supporting members are set based on the position of the hip joint of the person specified by the hip joint specifying unit in an operation of bending the person supported by the supporting members.

10. A transfer supporting apparatus according to claim 9, wherein the movement path setting unit sets the respective movement paths of the first and second supporting members so that the first and second supporting members move while maintaining specified distances from the position of the hip joint with the person and the supporting members supporting the person held in contact.

11. A transfer supporting apparatus according to claim 6, wherein the controller includes:
a permissible bending angle setting unit for setting a permissible bending angle of the hip joint of the person in an operation of lifting up the person by the first and second supporting members, and
a bending angle calculating unit for calculating a bending angle of the hip joint of the person to be lifted up by the first and second supporting members, and
the movements of the supporting members are corrected based on the operation of the operating unit so that the bending angle calculated by the bending angle calculating unit lies in the range of the permissible bending angle set by the permissible bending angle setting unit in the operation of lifting up the person by the first and second supporting members.

12. A transfer supporting apparatus according to claim 6, wherein the controller links movements of the first and second supporting members in a height direction and an operation of bending the hip joint of the person by the first and second supporting members in the operation of lifting up the person by the first and second supporting members.

13. A transfer supporting apparatus according to claim 1, wherein:
the controller includes a virtual potential energy setting unit for setting virtual potential energy specified by a magnitude of a force to be exerted to the supporting member according to a distance from the movement path set by the movement path setting unit to the supporting member, and
the operation correcting unit corrects the movement of the supporting member based on the operation of the operating unit by causing a force to be exerted to the supporting member so that the supporting member approaches the movement path based on the virtual potential energy set by the virtual potential energy setting unit.

14. A transfer supporting apparatus according to claim 13, further comprising a first detector for detecting a distance between the transfer supporting apparatus and the placing tool, wherein the virtual potential energy setting unit sets the virtual potential energy so that the force exerted to the supporting member increases as the distance detected by the first detector decreases.

15. A transfer supporting apparatus according to claim 13, wherein:
the controller includes a physique information storage for storing physique information of the person, and
the virtual potential energy setting unit sets the virtual potential energy according to the physique of the person based on the physique information stored in the physique information storage.

16. A transfer supporting apparatus according to claim 1, wherein the controller maintains the position and posture of the supporting member if no input is made by the operating unit for the operation of the supporting member.

17. A transfer supporting apparatus according to any claim 1, wherein the controller includes a correction canceling unit for canceling the function of the operation correcting unit.

18. A transfer supporting apparatus according to claim 1, wherein:
the controller includes a movement path correcting unit for correcting the movement path set by the movement path setting unit, and
the operation correcting unit corrects the movement of the supporting member based on the operation of the operating unit by driving the actuator so that the supporting member moves along the movement path corrected by the movement path correcting unit when the movement path is corrected by the movement path correcting unit.

19. A transfer supporting apparatus according to claim 1, further comprising a posture information storage for storing information on the posture of the person supported by the supporting member, wherein the movement path setting unit sets the movement path based on the information on the posture of the person stored in the posture information storage so that the head of the person supported by the supporting member is located higher than the feet.
